(19) United States
(12) Patent Application Publication
(10) Pub. No.: US 2015/0221043 A1
(43) Pub. Date: Aug. 6, 2015

(54) METHOD AND SYSTEM FOR PROVIDING GLOBAL READY FINANCIAL APPLICATIONS

(71) Applicant: Intuit Inc., Mountain View, CA (US)

(72) Inventors: Nemmara Chithambaram, Fremont, CA (US); Linu Mathew Koshy, Bangalore (IN); Anshu Verma, Bangalore (IN)

(73) Assignee: INTUIT INC., Mountain View, CA (US)

(21) Appl. No.: 14/245,912

(22) Filed: Apr. 4, 2014

(30) Foreign Application Priority Data
Feb. 5, 2014 (IN) 150/KOL/2014

(51) Int. Cl. G06Q 40/00; G06F 17/28; H04L 29/08

(52) U.S. Cl. CPC G06Q 40/12; H04L 67/306; G06F 17/28

(57) ABSTRACT

Global ready financial applications are provided that are dynamically composed using application independent global ready financial assets so that a single global ready financial application, once created, can be operationally and functionally optimized for multiple supported regions to be used by any party, in any, or all, of the multiple supported regions.

### BACKGROUND

Today a given financial management system, or individual applications, or micro applications, operating under the orchestration of a given financial management system, must be made relevant, applicable, and operable, within multiple geographic regions and under multiple governing rules and functionalities for these regions. Therefore, financial management system application developers need to be able to develop and provide financial management systems, or individual applications, or micro applications, optimized for multiple geographic regions.

Regional optimization of a financial management system, and/or the individual applications, or micro applications associated with a financial management system, includes some relatively simple optimizations such as adjusting the language and currency for a region. However, true regional optimization extends far beyond the translation of the languages and currencies involved. Indeed, a far more complex issue is how to deal with business, legal, and operational logic/functionality that changes from region to region.

For instance, financial identity data/requirements change from a Social Security Number (SSN#) in the United States, to a Permanent Account Number (PAN) in India, to a Tax File Number (TFN) in Australia. Similarly, currency and exchange rates are different for each region and between specific regions. In addition, tax models change from traditional sales tax in the United States, to a Value Added Tax (VAT) in Europe, to a Goods and Services Tax (GST) in the Asia Pacific region. Likewise, payment processors and processing protocols/requirements, bank feeds and security protocols/requirements, billing and entitlements procedures, etc., all have regional specific functionality and regional specific legalities and requirements.

Currently, financial management systems, and the individual applications, or micro applications, operating under the orchestration of the financial management systems, are typically localized for each region individually before the financial management systems are released in that region, e.g., region specific versions of the financial management systems, applications, or micro applications, are created individually with each version including its own region specific identity rules and formats; its own region specific billing and payment definitions, rules, functionality, and currencies; its own region specific tax configurations, models, definitions, rules, and functionality; its own region specific currency conversion functionality; its own region specific bank feeds and rules; its own region specific billing definitions, rules, and functionality; and its own other regionally defined rules of operation and functionality.

As a more specific example, currently, a separate regional version, or instance, of applications for generating profit and loss reports, applications for generating invoices; applications for tracking inventory; accounting applications; point of sale applications; applications for generating payroll; applications for calculating tax and/or submitting or paying taxes; applications for providing bank statements and on-line banking feeds; applications for generating various custom reports; and numerous other applications and micro-applications used by, and/or orchestrated through, a financial management system, must be generated and implemented separately.

Consequently, the process of creating numerous region specific versions of financial management systems, applications, or micro applications, is a very costly and resource consuming process; often taking years, and even decades, of man-hours to create each version. Due to this cost, and resource constraints, currently many financial management systems, applications, or micro applications, are never regionally optimized for numerous regions. In addition, if the financial management systems, applications, or micro applications, are regionally optimized for a region, the significant cost of localization/optimization is passed on to the user/customer.

Clearly this is a redundant and incredibly inefficient process. What is needed is a method and system for providing global ready financial applications that are created once and are then automatically regionally optimized in both form and function based on a determined region to be associated with specific instances of the global ready financial applications. In this way a single global ready financial application can be dynamically optimized for multiple supported regions and used by any party in the multiple supported regions without having to create separate regionally optimized versions of the global ready financial application for each region.

### SUMMARY

In accordance with one embodiment, global ready financial applications are provided that are dynamically composed using global ready financial assets so that a single global ready financial application, once created, can be operationally and functionally optimized for multiple supported regions to be used by any party, in any, or all, of the multiple supported regions.

In one embodiment, global ready financial application development is accelerated by creating global ready financial assets that are global ready financial application type independent and are specifically created to be used to compose multiple types, and instances, of global ready financial applications. In one embodiment, the global ready financial assets include regionally optimized business, legal, and operational models, logic, data, and/or functionality for two or more supported regions.

In various embodiments, specific examples of global ready financial assets include, but are not limited to, one or more of: an identity global ready financial asset to provide the identity model, logic, and functionality to the global ready financial applications for various supported regions; a tax model global ready financial asset to provide the tax model, logic, and functionality to be used by the global ready financial applications in various regions; a payment gateway global ready financial asset to provide the localized payment gateway model, logic, and functionality to be used by the global ready financial applications in various regions; a billing global ready financial asset to provide the billing and payment model, logic, and functionality to be used by the global ready financial applications in various regions; a bank feeds global ready financial asset to provide the bank feed model, logic, and functionality to the global ready financial applications for various regions; a currency conversion global ready financial asset to provide the local currency model, logic, and functionality for various regions; and/or any other global ready financial asset, or combination of global ready financial assets, as discussed herein, and/or as known in the art at the time of filing, and/or as developed after the time of filing.

In one embodiment, an application developer is provided access to the global ready financial assets and the global ready financial assets are used to compose regionally optimized instances of one or more global ready financial application types that perform any given global ready financial applications' core function and service in any of the two or more regions supported by the global ready financial assets.

In this way, application independent global ready financial assets are used to compose regionally optimized global ready financial applications so that an application developer can concentrate on the development of the core function or service provided by a given global ready financial application, or global ready financial application type, without having to create regionally optimized business, legal, and operational models, data, logic, and/or functionality to be used by each global ready financial application type in each region.

In one embodiment, a region to be associated with a given user of a global ready financial application instance is determined and then a regionally optimized global ready financial application instance is automatically composed using the relevant portion of the global ready financial assets for the determined region. The regionally optimized global ready financial application is then provided to the user and the core function of the regionally optimized global ready financial application is performed using the global ready financial assets.

### BRIEF DESCRIPTION OF THE DRAWINGS

FIG. 1 is a block diagram of an exemplary hardware architecture for implementing one embodiment;

FIG. 2 is a process diagram of a process for providing global ready financial applications in accordance with one embodiment;

FIG. 3 is a block diagram showing the relationship between global ready financial applications and global ready financial assets in accordance with one embodiment;

FIG. 4 is a block diagram showing the relationship between a given global ready financial application and the global ready financial assets in accordance with one embodiment;

FIG. 5 is a block diagram showing the composition of a given global ready financial application optimized for India using the global ready financial assets in accordance with one embodiment;

FIG. 6 is a block diagram showing the composition of a given global ready financial application optimized for the United States using the global ready financial assets in accordance with one embodiment;

FIG. 7 is a block diagram showing the composition of a given global ready financial application optimized for the United Kingdom using the global ready financial assets in accordance with one embodiment;

FIG. 8 is a block diagram showing the composition of a profit and loss report global ready financial application optimized for the India using the global ready financial assets in accordance with one embodiment;

FIG. 9 is a block diagram showing the composition of a profit and loss report global ready financial application optimized for the United States using the global ready financial assets in accordance with one embodiment;

FIG. 10 is a block diagram showing the composition of a profit and loss report global ready financial application optimized for the United Kingdom using the global ready financial assets in accordance with one embodiment;

FIG. 11 is a block diagram showing the composition of an invoicing global ready financial application optimized for the India using the global ready financial assets in accordance with one embodiment;

FIG. 12 is a block diagram showing the composition of an invoicing global ready financial application optimized for the United States using the global ready financial assets in accordance with one embodiment; and

FIG. 13 is a block diagram showing the composition of an invoicing global ready financial application optimized for the United Kingdom using the global ready financial assets in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, a system and method for providing global ready financial applications includes a process for providing global ready financial applications implemented by one or more processors associated with one or more computing systems.

As used herein, the term “computing system”, includes, but is not limited to, a desktop computing system; a portable computing system; a mobile computing system; a laptop computing system; a notebook computing system; a tablet computing system; a workstation; a server computing system; a mobile phone; a smart phone; a wireless telephone; a two-way pager; a Personal Digital Assistant (PDA); a media player, i.e., an MP3 player and/or other music and/or video player; an Internet appliance; a database system or storage cluster; a switching system; a router; any hardware system; any communications systems; any form of proxy system; a gateway system; a firewall system; a load balancing system; or any device, subsystem, or mechanism that includes components that can execute all, or part, of any one of the processes and/or operations as described herein.

In addition, as used herein, the term computing system, can denote, but is not limited to, systems made up of multiple desktop computing systems; portable computing systems; mobile computing systems; laptop computing systems; notebook computing systems; tablet computing systems; workstations; server computing systems; smart phones; wireless telephones; two-way pagers; Personal Digital Assistants (PDAs); media players; Internet appliances; database systems or storage clusters; switching systems; routers; any hardware systems; communications systems; any form of proxy systems; gateway systems; firewall systems; load balancing systems; or any devices that can be used to perform the processes and/or operations as described herein.

In one embodiment, one or more computing systems are connected by one or more communications channels, such as, but not limited to: any general network, communications network, or general network/communications network system; a cellular network; a wireless network; a combination of different network types; a public network; a private network; a satellite network; a cable network; or any other network capable of allowing communication between two or more computing systems, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more computing systems, whether available or known at the time of filing or as later developed.

In various embodiments, the one or more computing systems implementing the processes described herein are logically or physically located, and/or associated with, two or more computing environments. As used herein, the term “computing environment” includes, but is not limited to, a logical or physical grouping of connected or networked computing systems using the same infrastructure and systems such as, but not limited to, hardware systems, software systems, and networking/communications systems.

In accordance with one embodiment, the process for providing global ready financial applications is part of, linked to, or otherwise associated with, one or more financial management systems used by one or more of the one or more individuals.

Herein the terms “individual” and “user” are used interchangeably and include, but are not limited to, any individual party and/or entity as discussed herein, and/or as defined in the art at the time of filing, and/or as defined after the time of filing.

Herein, a financial management system can be, but is not limited to, any data management system implemented on a computing system and/or accessed through a network that processes financial data from one or more sources.

For instance, as illustrative examples, herein, the term “financial management system” can denote, but is not limited to, one or more of the following types of financial management systems: computing system implemented, and/or online, personal and/or business financial management systems, packages, programs, modules, or applications; computing system implemented, and/or online, personal and/or business tax preparation systems, packages, programs, modules, or applications; computing system implemented, and/or online, personal and/or business accounting and/or invoicing systems, packages, programs, modules, or applications; and various other personal and/or business electronic data management systems, packages, programs, modules, or applications, whether known at the time of filling or as developed later.

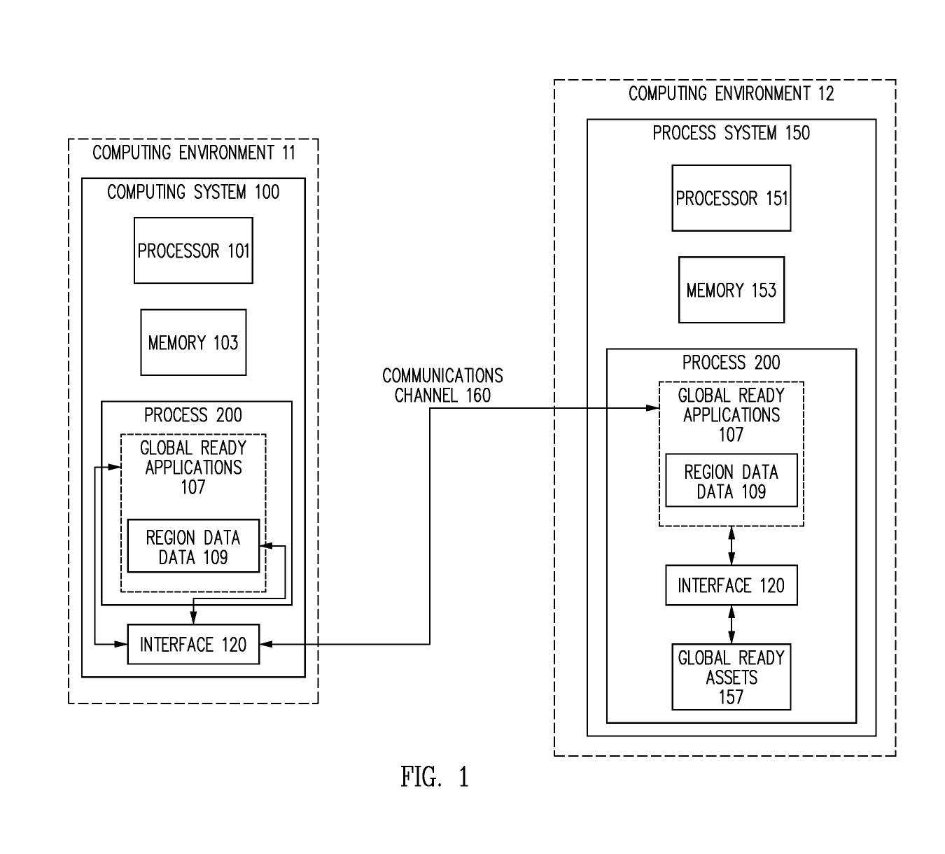

FIG. 1 is a functional diagram of the interaction of various elements associated with one embodiment of the methods and systems for providing global ready financial applications discussed herein. Of particular note, the various elements in FIG. 1 are shown for illustrative purposes as being associated with specific computing environments, such as computing environment 11 and computing environment 12. However, the exemplary placement of the various elements within these environments and systems in FIG. 1 is made for illustrative purposes only and, in various embodiments, any individual element shown in FIG. 1, or combination of elements shown in FIG. 1, can be implemented and/or deployed on any of one or more various computing environments or systems, and/or architectural or infrastructure components, such as one or more hardware systems, one or more software systems, one or more data centers, more or more clouds or cloud types, one or more third party service capabilities, or any other computing environments, architectural, and/or infrastructure components as discussed herein, and/or as known in the art at the time of filing, and/or as developed/made available after the time of filing.

As used herein, the term “region” refers to any unit of geographic location where differences or similarities relevant to a given global ready financial application, or a user of a global ready financial application, may exist. Thus, regions may be different due to distance, language spoken, political or financial practices, cultural differences, customs and practices of the people or professions within the region, or any other distinguishing factor which is relevant to the functions and processes presented in an application program, such as a global ready financial application.

As noted above, today a given financial management system, or individual applications, or micro applications, operating under the orchestration of a given financial management system, must be made relevant, applicable, and operable, within multiple geographic regions and under multiple governing rules and functionalities for these regions. Therefore, financial management system application developers need to be able to develop and provide financial management systems, or individual applications, or micro applications, optimized for multiple geographic regions.

However, as also noted above, true regional optimization extends far beyond the translation of the languages and currencies involved. Indeed, a far more complex issue is how to deal with business, legal, and operational logic/functionality that changes from region to region. For instance, financial identity data/requirements change from a Social Security Number (SSN#) in the United States, to a Permanent Account Number (PAN) in India, to a Tax File Number (TFN) in Australia. Similarly, currency and exchange rates are different for each region and between specific regions. In addition, tax models change from traditional sales tax in the United States, to a Value Added Tax (VAT) in Europe, to a Goods and Services Tax (GST) in the Asia Pacific region. Likewise, payment processors and processing protocols/requirements, bank feeds and security protocols/requirements, billing and entitlements procedures, etc., all have regional specific functionality and regional specific legalities and requirements.

Currently, financial management systems, and the individual applications, or micro applications, operating under the orchestration of the financial management systems, are typically localized for each region individually before the financial management systems are released in that region, e.g., region specific versions of the financial management systems, applications, or micro applications, are created individually with each version including its own region specific identity rules and formats; its own region specific billing and payment definitions, rules, functionality, and currencies; its own region specific tax configurations, models, definitions, rules, and functionality; its own region specific currency conversion functionality; its own region specific bank feeds and rules; its own region specific billing definitions, rules, and functionality; and its own other regionally defined rules of operation and functionality.

As a more specific example, currently, a separate regional version, or instance, of applications for generating profit and loss reports, applications for generating invoices; applications for tracking inventory; accounting applications; point of sale applications; applications for generating payroll; applications for calculating tax and/or submitting or paying taxes; applications for providing bank statements and on-line banking feeds; applications for generating various custom reports; and numerous other applications and micro-applications used by, and/or orchestrated through, a financial management system, must be generated and implemented separately. Consequently, the process of creating numerous region specific versions of financial management systems, applications, or micro applications, is a very costly and resource consuming process; often taking years, and even decades, of man-hours to create each version. Due to this cost, and resource constraints, currently many financial management systems, applications, or micro applications, are never regionally optimized for numerous regions. In addition, if the financial management systems, applications, or micro applications, are regionally optimized for a region, the significant cost of localization/optimization is passed on to the user/customer.

As also noted above, this current situation is extremely inefficient and ineffective with the result that many financial management systems, and applications, or micro applications, associated with financial management systems, are never optimized for, and are therefore never fully functional within, many geographic regions.

To address this issue, in one embodiment, global ready financial applications are provided that are dynamically composed using global ready financial assets shared by multiple global ready financial applications, and global ready financial application instances, so that a single global ready financial application, once created, can be operationally and functionally optimized as needed for multiple supported regions to be used by any party, in any, or all, of the multiple supported regions.

In one embodiment, global ready financial application development is accelerated by creating global ready financial assets that are global ready financial application type independent and are specifically created to be used to compose multiple types, and instances, of global ready financial applications.

In various embodiments, specific examples of global ready financial applications include, but are not limited to, global ready financial applications for generating profit and loss reports, global ready financial applications for generating invoices, global ready financial applications for generating payroll, global ready financial applications for providing bank statements and on-line banking feeds, global ready financial applications for generating various custom reports, and any other global ready financial applications, and/or global ready financial micro-applications, as discussed herein, and/or as known in the art at the time of filing, and/or as developed after the time of filing.

As noted above, FIG. 1 is a block diagram of an exemplary hardware architecture for implementing one embodiment. As seen in FIG. 1, in one embodiment, global ready financial applications 107 are implemented, or provided, locally via a process 200 module of a computing system 100. As also seen in FIG. 1, process module 200 also includes region data 109 which, as discussed in more detail below, provides information regarding a region to be associated with a user of computing system 100.

In various embodiments, computing system 100 is any computing system used by a user or developer to compose and access regionally optimized global ready financial applications in accordance with the processes discussed herein.

As also seen in FIG. 1, computing system 100 includes processor 101 for executing various machine readable instructions; memory 103 for storing and/or buffering data; and interface 120 for providing an interface between global ready financial applications 107 of computing system 100 and global ready financial assets 157 of process system 150. Global ready financial assets 157 and process system 150 are discussed in more detail below.

In various embodiments, computing system 100 may further include standard interface devices such as a keyboard (not shown), a mouse (not shown), a printer (not shown), as well as, one or more standard input/output (I/O) devices (not shown), such as a compact disk (CD) or Digital Video Disc (DVD) drive, floppy disk drive, or other digital or waveform port, or other device capable of inputting data to, and outputting data from, computing system 100, whether available or known at the time of filing or as later developed.

As also seen in FIG. 1, in one embodiment, global ready financial applications 107 are implemented, or provided, remotely, via a process 200 module of process system 150. In this embodiment, the user of computing system 100 remotely accesses process module 200 and global ready financial applications 107 using interface 120. As seen in FIG. 1, process module 200 also includes region data 109 as received, in one embodiment, from computing system 100, which, as discussed in more detail below, provides information regarding a region to be associated with a user of computing system 100.

In various embodiments, process system 150 is any computing system as discussed herein, and/or as known in the art at the time of filing, and/or as developed after the time of filing.

As also seen in FIG. 1, process system 150 includes processor 151 for executing various machine readable instructions; memory 153 for storing and/or buffering data; and interface 120 for providing an interface between global ready financial applications 107 and global ready financial assets 157.

In various embodiments, process system 150 may further include standard interface devices such as a keyboard (not shown), a mouse (not shown), a printer (not shown), as well as, one or more standard input/output (I/O) devices (not shown), such as a compact disk (CD) or Digital Video Disc (DVD) drive, floppy disk drive, or other digital or waveform port, or other device capable of inputting data to, and outputting data from, process system 150, whether available or known at the time of filing or as later developed.

As seen in FIG. 1, in one embodiment computing system 100 is implemented in computing environment 11 while process system 150 is implemented in computing environment 12.

As discussed above, the various elements in FIG. 1 are shown for illustrative purposes as being associated with specific computing environments, such as computing environment 11 and computing environment 12. However, the exemplary placement of the various elements within these environments and systems in FIG. 1 is made for illustrative purposes only and, in various embodiments, any individual element shown in FIG. 1, or combination of elements shown in FIG. 1, can be implemented and/or deployed on any of one or more various computing environments or systems, and/or architectural or infrastructure components, such as one or more hardware systems, one or more software systems, one or more data centers, more or more clouds or cloud types, one or more third party service capabilities, or any other computing environments, architectural, and/or infrastructure components as discussed herein, and/or as known in the art at the time of filing, and/or as developed/made available after the time of filing.

As seen in FIG. 1, computing system 100 is commutatively coupled to process system 150 via communications channel 160. In various embodiments, communications channel 160 can be, but is not limited to: any network; a mobile communication link, such as a mobile phone link; a land-line phone link; a cable-based communications channel; a satellite communications channel; the Internet, a cloud, or other network communications channel; and/or any other communications channel, or combination of communications channels, as discussed herein, and/or as known in the art at the time of filing, and/or as developed after the time of filing.

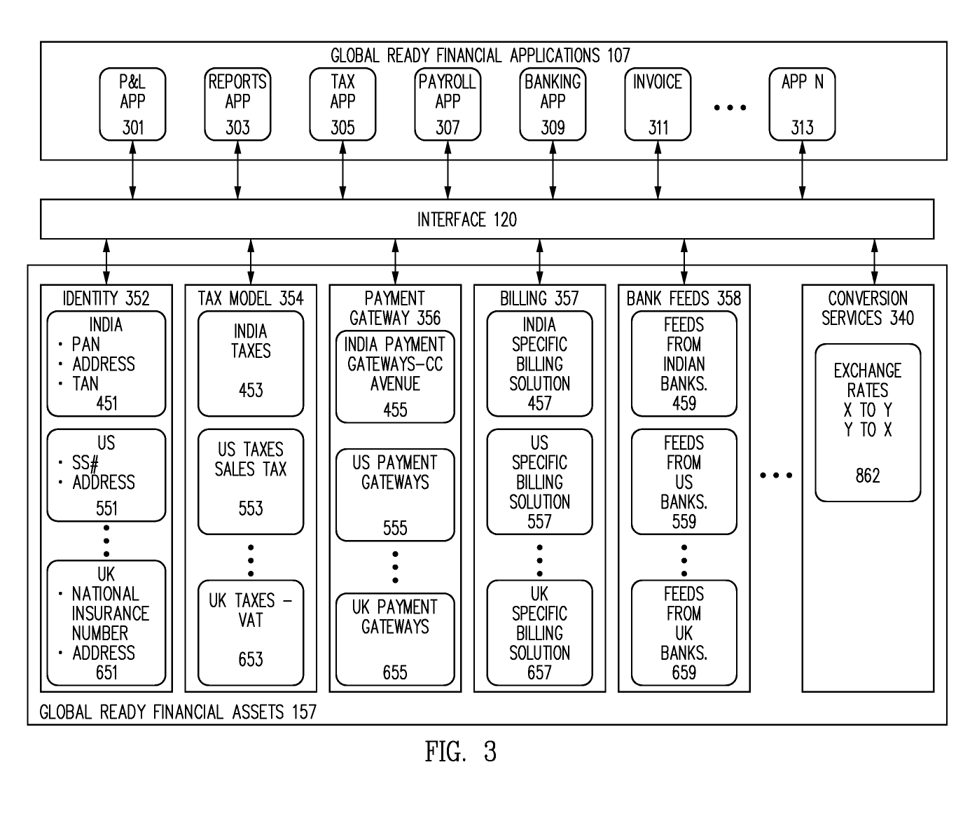

FIG. 3 is a block diagram showing the relationship between global ready financial applications 107 of FIGS. 1 and 3, and global ready financial assets 157 of FIGS. 1 and 3 in accordance with one embodiment. Referring to FIG. 3, exemplary global ready financial applications 107 include a Profit and Loss (P&L) global ready financial application 301 for generating P&L reports; reports global ready financial application 303 for generating various customized financial reports; tax global ready financial application 305 for generating and/or filing tax documents; payroll global ready financial application 307 for generating payrolls; banking global ready financial application 309 for providing on-line bank reports and data; invoice global ready financial application 311 for generating invoices; and general application 313 representing any global ready financial application as discussed herein, and/or as known in the art at the time of filing, and/or as developed, or becomes known, after the time of filing

In one embodiment, the global ready financial assets include regionally optimized business, legal, and operational models, logic, data, and/or functionality for two or more supported regions that pre-created and pre-deployed for use by the global ready financial applications.

As noted above, FIG. 3 is a block diagram showing the relationship between global ready financial applications 107 of FIGS. 1 and 3, and global ready financial assets 157 of FIGS. 1 and 3 in accordance with one embodiment. Referring to FIG. 3, as a specific illustrative example, in one embodiment, global ready financial assets 157 include, but are not limited to, an identity global ready financial asset 352 to provide the identity model, logic, and functionality to global ready financial applications 107 for various ones of the two or more supported regions, e.g., Social Security Number, or Permanent Account Number (PAN), or Tax File Number (TFN), etc., as needed.

As seen in FIG. 3, identity global ready financial asset 352 includes regionally optimized identity model, logic, and functionality for India 451 to provide the identity model, logic, and functionality to any of global ready financial applications 107 for India. Likewise, identity global ready financial asset 352 includes regionally optimized identity model, logic, and functionality for the United States (US) 551 to provide the identity model, logic, and functionality to any of global ready financial applications 107 for the US. Likewise, identity global ready financial asset 352 includes regionally optimized identity model, logic, and functionality for the United Kingdom (UK) 651 to provide the identity model, logic, and functionality to any of global ready financial applications 107 for the UK.

Those of skill in the art will readily recognize that while only three examples of regionally optimized identity model, logic, and functionality are shown for identity global ready financial asset 352, i.e., India 451, US 551, and UK 651, numerous other regionally optimized identity model, logic, and functionality for numerous other regions can be provided in various other embodiments.

Referring back to FIG. 3, as a specific illustrative example, in one embodiment, global ready financial assets 157 include, but are not limited to, a tax model global ready financial asset 354 to provide the tax model, logic, and functionality to be used by global ready financial applications 107 in various regions of the two or more supported regions in order to calculate and employ, as an example, and as required, a sales tax model, logic, and functionality, and/or a Value Added Tax (VAT) model, logic, and functionality, and/or a Goods and Services Tax (GST) model, logic, and functionality, and/or any other tax model, as discussed herein, and/or as known in the art at the time of filing, and/or as developed after the time of filing; and/or provide the proper agency integration for various regions of the two or more supported regions, e.g., IRS, TDS, etc.; and/or provide the correct e-filing integration model, logic, and functionality for various regions of the two or more supported regions; and/or any other tax model, logic, and functionality as discussed herein, and/or as known in the art at the time of filing, and/or as developed after the time of filing.

As seen in FIG. 3, tax model global ready financial asset 354 includes regionally optimized tax model, logic, and functionality for India 453 to provide the tax model, logic, and functionality to any of global ready financial applications 107 for India. Likewise, tax model global ready financial asset 354 includes regionally optimized identity model, logic, and functionality for the United States (US) 553 to provide the tax model, logic, and functionality to any of global ready financial applications 107 for the US Likewise, tax model global ready financial asset 354 includes regionally optimized tax model, logic, and functionality for the United Kingdom (UK) 653 to provide the identity model, logic, and functionality to any of global ready financial applications 107 for the UK.

Those of skill in the art will readily recognize that while only three examples of regionally optimized identity model, logic, and functionality are shown for tax model global ready financial asset 354, i.e., India 453, US 553, and UK 653, numerous other regionally optimized identity model, logic, and functionality for numerous other regions can be provided in various other embodiments.

Referring to FIG. 3, as a specific illustrative example, in one embodiment, global ready financial assets 157 include, but are not limited to, a payment gateway global ready financial asset 356 to provide the localized payment gateway model, logic, and functionality to be used by global ready financial applications 107 in various regions of the two or more supported regions.

As seen in FIG. 3, payment gateway global ready financial asset 356 includes regionally optimized payment gateway model, logic, and functionality for India 455 to provide the payment gateway model, logic, and functionality to any of global ready financial applications 107 for India. Likewise, payment gateway global ready financial asset 356 includes regionally optimized payment gateway model, logic, and functionality for the United States (US) 555 to provide the payment gateway model, logic, and functionality to any of global ready financial applications 107 for the US. Likewise, payment gateway global ready financial asset 356 includes regionally optimized payment gateway model, logic, and functionality for the United Kingdom (UK) 655 to provide the payment gateway model, logic, and functionality to any of global ready financial applications 107 for the UK.

Those of skill in the art will readily recognize that while only three examples of regionally optimized payment gateway model, logic, and functionality are shown for payment gateway global ready financial asset 356, i.e., India 455, US 555, and UK 655, numerous other regionally optimized payment gateway model, logic, and functionality for numerous other regions can be provided in various other embodiments.

Referring to FIG. 3, as a specific illustrative example, in one embodiment, global ready financial assets 157 include, but are not limited to, a billing global ready financial asset 357 to provide the billing and payment model, logic, and functionality to be used by global ready financial applications 107 in various regions of the two or more supported regions, e.g., the revenue recognition model, logic, and functionality for various regions of the two or more supported regions; the billing regulations and procedures model, logic, and functionality for various regions of the two or more supported regions; and/or any other billing and payment model, logic, and functionality as discussed herein, and/or as known in the art at the time of filing, and/or as becomes known after the time of filing.

As seen in FIG. 3, billing global ready financial asset 357 includes regionally optimized billing model, logic, and functionality for India 457 to provide the identity model, logic, and functionality to any of global ready financial applications 107 for India. Likewise, billing global ready financial asset 357 includes regionally optimized billing model, logic, and functionality for the United States (US) 557 to provide the billing model, logic, and functionality to any of global ready financial applications 107 for the US. Likewise, billing global ready financial asset 357 includes regionally optimized billing model, logic, and functionality for the United Kingdom (UK) 657 to provide the identity model, logic, and functionality to any of global ready financial applications 107 for the UK.

Those of skill in the art will readily recognize that while only three examples of regionally optimized billing model, logic, and functionality are shown for billing global ready financial asset 357, i.e., India 457, US 557, and UK 657, numerous other regionally optimized billing model, logic, and functionality for numerous other regions can be provided in various other embodiments.

Referring to FIG. 3, as a specific illustrative example, in one embodiment, global ready financial assets 157 include, but are not limited to, a bank feeds global ready financial asset 358 to provide the bank feed model, logic, and functionality to global ready financial applications 107 for various regions of the two or more supported regions; the data movement model, logic, and functionality to global ready financial applications 107 for various regions of the two or more supported regions; and/or any other bank feed model, logic, and functionality as discussed herein, and/or as known in the art at the time of filing, and/or as becomes known after the time of filing.

As seen in FIG. 3, bank feeds global ready financial asset 358 includes regionally optimized bank feeds model, logic, and functionality for India 459 to provide the bank feeds model, logic, and functionality to any of global ready financial applications 107 for India. Likewise, bank feeds global ready financial asset 358 includes regionally optimized bank feeds model, logic, and functionality for the United States (US) 559 to provide the bank feeds model, logic, and functionality to any of global ready financial applications 107 for the US Likewise, bank feeds global ready financial asset 358 includes regionally optimized bank feeds model, logic, and functionality for the United Kingdom (UK) 659 to provide the bank feeds model, logic, and functionality to any of global ready financial applications 107 for the UK.

Those of skill in the art will readily recognize that while only three examples of regionally optimized bank feeds model, logic, and functionality are shown for bank feeds global ready financial asset 358, i.e., India 459, US 559, and UK 659, numerous other regionally optimized bank feeds model, logic, and functionality for numerous other regions can be provided in various other embodiments.

Referring to FIG. 3, as a specific illustrative example, in one embodiment, global ready financial assets 157 include, but are not limited to, a currency conversion global ready financial asset 340 to provide the local currency model, logic, and functionality for various regions of the two or more supported regions; and/or the currency conversion model, logic, and functionality for the global ready financial applications for various regions of the two or more supported regions.

In one embodiment, global ready financial assets 157 include, but are not limited to, other global ready financial assets not shown in FIG. 3 such as a user contribution and/or local templates global ready financial asset to provide the personalized service model, logic, and/or functionality for the global ready financial applications for various regions of the two or more supported regions; the user customizations and template sharing data, logic, and functionality for the global ready financial applications for various regions of the two or more supported regions; and/or any other personalized service model, logic, and/or functionality discussed herein, and/or as known in the art at the time of filing, and/or as developed/becomes known after the time of filing.

In one embodiment, global ready financial assets 157 include, but are not limited to, any combination of the global ready financial assets discussed herein, or any other global ready financial assets desired, and/or as known in the art at the time of filing, and/or as developed/becomes known after the time of filing.

Also shown in FIG. 3 is interface 120 between global ready financial applications 107 and global ready financial assets 157. In various embodiments, interface 120 is an Application Program Interface (API) or any other interface, or user interface, as discussed herein, and/or as known in the art at the time of filing, and/or as developed/becomes known after the time of filing.

In one embodiment, an application developer and/or user is provided access to the global ready financial assets and the global ready financial assets are used to compose regionally optimized instances of one or more global ready financial application types that perform any given global ready financial applications' core function and service in any of the two or more regions supported by the global ready financial assets.

In this way, application independent global ready financial assets are used to compose regionally optimized global ready financial applications so that an application developer can concentrate on the development of the core function or service provided by a given global ready financial application, or global ready financial application type, without having to create regionally optimized business, legal, and operational models, data, logic, and/or functionality to be used by each global ready financial application type in each region.

In one embodiment, a region to be associated with a given global ready financial application instance is determined. In one embodiment, the region to be associated with a given global ready financial application instance is obtained from one or more sources. In one embodiment, the region to be associated with a given global ready financial application instance is determined, at least in part, based on an IP address associated with computing system used by the party accessing the global ready financial application.

As persons of ordinary skill will readily appreciate, an IP address is typically assigned to a computing system, by a network or other communication channel the computing system is using, and the assigned IP address often has numerical similarities with other computing systems located nearby on the same network. In one embodiment, in the case of the computing system being coupled to a public network through a private network, as one example, either of a private network IP address associated with the computing system or a public network IP address represented in network communication of the computing system may be used, at least in part, to determine the region to be associated with a given global ready financial application instance.

In one embodiment, the region to be associated with a given global ready financial application instance is determined, at least in part, based on local, language, or other information received as part of the request to access the global ready financial application, such as a locale indicator provided by a web browser application being used by the party.

In one embodiment, the region to be associated with a given global ready financial application instance is determined, at least in part, based on user profile data or other information provided by a user of the global ready financial application. For example, the initial determination of a geographic location may be made after the user is recognized as an authorized user, or at any time appropriate.

Referring back to FIG. 1, data indicating the region to be associated with a given global ready financial application instance, however determined, is represented by region data 109. As discussed below, in one embodiment, once obtained, region data 109 is provided to process system 150 and global ready financial assets 157.

In one embodiment, once the region to be associated with a given global ready financial application instance is determined, a regionally optimized global ready financial application instance is automatically composed using the relevant portions of the global ready financial assets for the determined region. Consequently, in one embodiment, when a first instance of a first type of global ready financial application is being developed or used, a first region to be associated with the first instance of the first global ready financial application is determined. In one embodiment, based on the application type of first type of global ready financial application, one or more of the global ready financial assets determined to be required by the first type of global ready financial application are accessed and, based on the determined first region to be associated with the first instance of the first type of global ready financial application, regionally optimized business, legal, and operational data, logic, and/or functionality for the determined first region included in the one or more global ready financial assets is used to compose a first regionally optimized instance of the first type of global ready financial application.

In one embodiment, when a second instance of the first type of global ready financial application is being developed or used, a second region to be associated with the second instance of the first global ready financial application is determined. In one embodiment, based on the application type of first type of global ready financial application, the one or more global ready financial assets required by the first type of global ready financial application are accessed and, based on the determined second region to be associated with the second instance of the first global ready financial application, regionally optimized business, legal, and operational data, logic, and/or functionality for the determined first region included in the one or more global ready financial assets is used to compose a second regionally optimized instance of the first type of global ready financial application.

In one embodiment, when a first instance of a second type of global ready financial application is being developed or used, a first region to be associated with the first instance of the second global ready financial application is determined. In one embodiment, based on the application type of second type of global ready financial application, one or more of the global ready financial assets determined to be required by the second type of global ready financial application are accessed and, based on the determined first region to be associated with the first instance of the second type of global ready financial application, regionally optimized business, legal, and operational data, logic, and/or functionality for the determined first region included in the one or more global ready financial assets is used to compose a first regionally optimized instance of the second type of global ready financial application.

In one embodiment, when a second instance of the second type of global ready financial application is being developed, a second region to be associated with the second instance of the second global ready financial application is determined. In one embodiment, based on the application type of second type of global ready financial application, the one or more global ready financial assets required by the second type of global ready financial application are accessed and, based on the determined second region to be associated with the second instance of the second global ready financial application, regionally optimized business, legal, and operational data, logic, and/or functionality for the determined second region included in the one or more global ready financial assets is used to compose a second regionally optimized instance of the second type of global ready financial application.

Using the method and system for providing global ready financial applications discussed herein, global ready financial applications are provided that are dynamically composed using global ready financial assets. As a result, global ready financial applications are provided that are automatically regionally optimized in both form and function based on a determined region to be associated with specific instances of the global ready financial applications. In this way, a single global ready financial application can be dynamically optimized for multiple supported regions and used by any party in multiple supported regions without having to create separate regionally optimized versions of the global ready financial application for each region.

In the discussion above, certain aspects of one embodiment include processes, sub-processes, steps, operations and/or instructions described herein for illustrative purposes in a particular order and/or grouping. However, the particular order and/or grouping shown and discussed herein are illustrative only and not limiting. Those of skill in the art will recognize that other orders and/or grouping of the processes, sub-processes, steps, operations and/or instructions are possible and, in some embodiments, one or more of the processes, sub-processes, steps, operations and/or instructions discussed above can be combined and/or deleted. In addition, portions of one or more of the processes, sub-processes, steps, operations and/or instructions can be re-grouped as portions of one or more other of processes, sub-processes, steps, operations and/or instructions discussed herein. Consequently, the particular order and/or grouping of the processes, sub-processes, steps, operations and/or instructions discussed herein do not limit the scope of the invention as claimed below.

### Process

In accordance with one embodiment, global ready financial applications are provided that are dynamically composed using global ready financial assets so that a single global ready financial application, once created, can be operationally and functionally optimized for multiple supported regions to be used by any party, in any, or all, of the multiple supported regions.

In one embodiment, global ready financial application development is accelerated by creating global ready financial assets that are global ready financial application type independent and are specifically created to be used to compose multiple types, and instances, of global ready financial applications. In one embodiment, the global ready financial assets include regionally optimized business, legal, and operational models, logic, data, and/or functionality for two or more supported regions.

In various embodiments, specific examples of global ready financial assets include, but are not limited to, one or more of: an identity global ready financial asset to provide the identity model, logic, and functionality to the global ready financial applications for various supported regions; a tax model global ready financial asset to provide the tax model, logic, and functionality to be used by the global ready financial applications in various regions; a payment gateway global ready financial asset to provide the localized payment gateway model, logic, and functionality to be used by the global ready financial applications in various regions; a billing global ready financial asset to provide the billing and payment model, logic, and functionality to be used by the global ready financial applications in various regions; a bank feeds global ready financial asset to provide the bank feed model, logic, and functionality to the global ready financial applications for various regions; a currency conversion global ready financial asset to provide the local currency model, logic, and functionality for various regions; and/or any other global ready financial asset, or combination of global ready financial assets, as discussed herein, and/or as known in the art at the time of filing, and/or as developed after the time of filing.

In one embodiment, an application developer is provided access to the global ready financial assets and the global ready financial assets are used to compose regionally optimized instances of one or more global ready financial application types that perform any given global ready financial applications' core function and service in any of the two or more regions supported by the global ready financial assets.

In this way, application independent global ready financial assets are used to compose regionally optimized global ready financial applications so that an application developer can concentrate on the development of the core function or service provided by a given global ready financial application, or global ready financial application type, without having to create regionally optimized business, legal, and operational models, data, logic, and/or functionality to be used by each global ready financial application type in each region.

In one embodiment, a region to be associated with a given user of a global ready financial application instance is determined and then a regionally optimized global ready financial application instance is automatically composed using the relevant portion of the global ready financial assets for the determined region. The regionally optimized global ready financial application is then provided to the user and the core function of the regionally optimized global ready financial application is performed using the global ready financial assets.

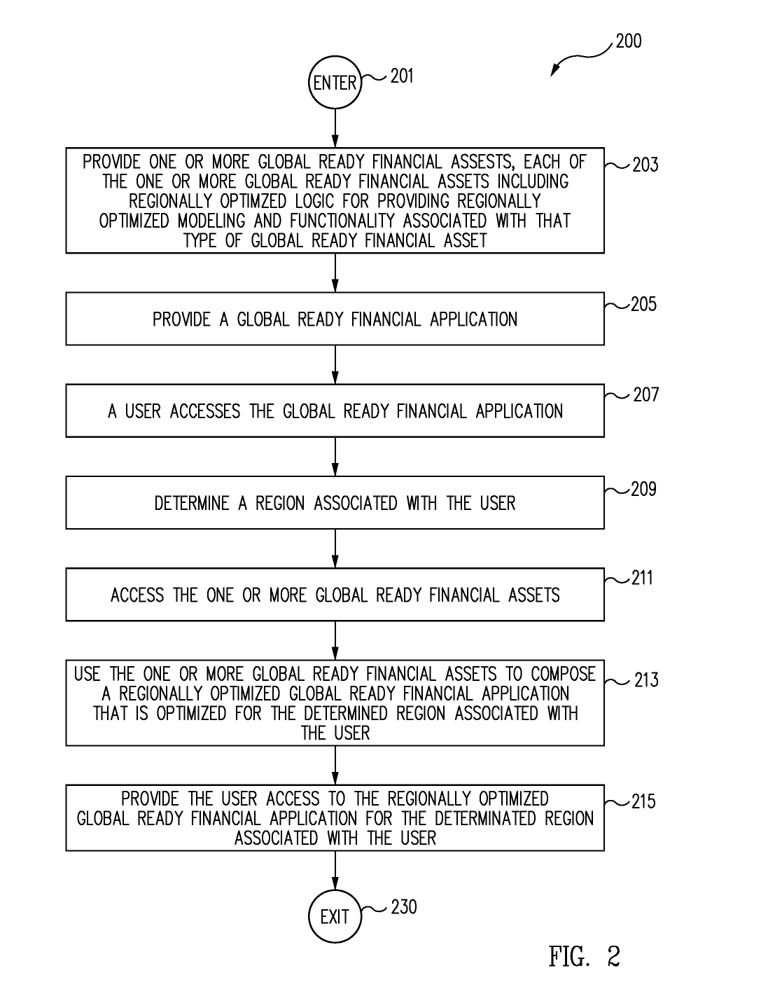

FIG. 2 is a flow chart depicting a process 200 for providing global ready financial applications in accordance with one embodiment. Process 200 for providing global ready financial applications begins at ENTER OPERATION 201 of FIG. 2 and process flow proceeds to PROVIDE ONE OR MORE GLOBAL READY FINANCIAL ASSETS, EACH OF THE ONE OR MORE GLOBAL READY FINANCIAL ASSETS INCLUDING REGIONALLY OPTIMIZED LOGIC FOR PROVIDING REGIONALLY OPTIMIZED MODELING AND FUNCTIONALITY ASSOCIATED WITH THAT TYPE OF GLOBAL READY FINANCIAL ASSET OPERATION 203.

As noted above, today a given financial management system, or individual applications, or micro applications, operating under the orchestration of a given financial management system, must be made relevant, applicable, and operable, within multiple geographic regions and under multiple governing rules and functionalities for these regions. Therefore, financial management system application developers need to be able to develop and provide financial management systems, or individual applications, or micro applications, optimized for particular geographic regions.

However, as also noted above, true regional optimization extends far beyond the translation of the languages and currencies involved. Indeed, a far more complex issue is how to deal with business, legal, and operational logic/functionality that changes from region to region. For instance, financial identity data/requirements change from a Social Security Number (SSN#) in the United States, to a Permanent Account Number (PAN) in India, to a Tax File Number (TFN) in Australia. Similarly, currency and exchange rates are different for each region and between specific regions. In addition, tax models change from traditional sales tax in the United States, to a Value Added Tax (VAT) in Europe, to a Goods and Services Tax (GST) in the Asia Pacific region. Likewise, payment processors and processing protocols/requirements, bank feeds and security protocols/requirements, billing and entitlements procedures, etc., all have regional specific functionality and regional specific legalities and requirements.

Currently, financial management systems, and the individual applications, or micro applications, operating under the orchestration of the financial management systems, are typically localized for each region individually before the financial management systems are released in that region, e.g., region specific versions of the financial management systems, applications, or micro applications, are created individually with each version including its own region specific identity rules and formats; its own region specific billing and payment definitions, rules, functionality, and currencies; its own region specific tax configurations, models, definitions, rules, and functionality; its own region specific currency conversion functionality; its own region specific bank feeds and rules; its own region specific billing definitions, rules, and functionality; and its own other regionally defined rules of operation and functionality.

As a more specific example, currently, a separate regional version, or instance, of applications for generating profit and loss reports, applications for generating invoices; applications for tracking inventory; accounting applications; point of sale applications; applications for generating payroll; applications for calculating tax and/or submitting or paying taxes; applications for providing bank statements and on-line banking feeds; applications for generating various custom reports; and numerous other applications and micro-applications used by, and/or orchestrated through, a financial management system, must be generated and implemented separately. Consequently, the process of creating numerous region specific versions of financial management systems, applications, or micro applications, is a very costly and resource consuming process; often taking years, and even decades, of man-hours to create each version. Due to this cost, and resource constraints, currently many financial management systems, applications, or micro applications, are never regionally optimized for numerous regions. In addition, if the financial management systems, applications, or micro applications, are regionally optimized for a region, the significant cost of localization/optimization is passed on to the user/customer.

As also noted above, this current situation is extremely inefficient and ineffective with the result that many financial management systems, and applications, or micro applications, associated with financial management systems, are never optimized for, and are therefore never fully functional within, many geographic regions.

To address this issue, in one embodiment, global ready financial applications are provided that are dynamically composed using global ready financial assets shared by multiple global ready financial applications, and global ready financial application instances, so that a single global ready financial application, once created, can be operationally and functionally optimized as needed for multiple supported regions to be used by any party, in any, or all, of the multiple supported regions.

In one embodiment, global ready financial application development is accelerated by creating global ready financial assets that are global ready financial application type independent and are specifically created to be used to compose multiple types, and instances, of global ready financial applications.

In various embodiments, specific examples of types of global ready financial applications include, but are not limited to, global ready financial applications for generating profit and loss reports, global ready financial applications for generating invoices, global ready financial applications for generating payroll, global ready financial applications for providing bank statements and on-line banking feeds, global ready financial applications for generating various custom reports, and any other global ready financial applications, and/or global ready financial micro-applications, as discussed herein, and/or as known in the art at the time of filing, and/or as developed after the time of filing.

To this end, at PROVIDE ONE OR MORE GLOBAL READY FINANCIAL ASSETS, EACH OF THE ONE OR MORE GLOBAL READY FINANCIAL ASSETS INCLUDING REGIONALLY OPTIMIZED LOGIC FOR PROVIDING REGIONALLY OPTIMIZED MODELING AND FUNCTIONALITY ASSOCIATED WITH THAT TYPE OF GLOBAL READY FINANCIAL ASSET OPERATION 203 global ready financial assets are pre-created, pre-deployed, and/or provided that include regionally optimized business, legal, and operational models, logic, data, and/or functionality for two or more supported regions for use by the global ready financial applications.

As noted above, FIG. 3 is a block diagram showing the relationship between global ready financial applications 107 of FIGS. 1 and 3, and global ready financial assets 157 of FIGS. 1 and 3 in accordance with one embodiment. Referring to FIG. 3, as a specific illustrative example, in one embodiment, global ready financial assets 157 include, but are not limited to, an identity global ready financial asset 352 to provide the identity model, logic, and functionality to global ready financial applications 107 for various ones of the two or more supported regions, e.g., Social Security Number, or Permanent Account Number (PAN), or Tax File Number (TFN), etc., as needed.

As seen in FIG. 3, identity global ready financial asset 352 includes regionally optimized identity model, logic, and functionality for India 451 to provide the identity model, logic, and functionality to any of global ready financial applications 107 for India.

Likewise, identity global ready financial asset 352 includes regionally optimized identity model, logic, and functionality for the United States (US) 551 to provide the identity model, logic, and functionality to any of global ready financial applications 107 for the US.

Likewise, identity global ready financial asset 352 includes regionally optimized identity model, logic, and functionality for the United Kingdom (UK) 651 to provide the identity model, logic, and functionality to any of global ready financial applications 107 for the UK.

Those of skill in the art will readily recognize that while only three examples of regionally optimized identity model, logic, and functionality are shown for identity global ready financial asset 352, i.e., India 451, US 551, and UK 651, numerous other regionally optimized identity model, logic, and functionality for numerous other regions can be provided in various other embodiments.

Referring back to FIG. 3, as a specific illustrative example, in one embodiment, global ready financial assets 157 include, but are not limited to, a tax model global ready financial asset 354 to provide the tax model, logic, and functionality to be used by global ready financial applications 107 in various regions of the two or more supported regions in order to calculate and employ, as an example, and as required, a sales tax model, logic, and functionality, and/or a Value Added Tax (VAT) model, logic, and functionality, and/or a Goods and Services Tax (GST) model, logic, and functionality, and/or any other tax model, as discussed herein, and/or as known in the art at the time of filing, and/or as developed after the time of filing; and/or provide the proper agency integration for various regions of the two or more supported regions, e.g., IRS, TDS, etc.; and/or provide the correct e-filing integration model, logic, and functionality for various regions of the two or more supported regions; and/or any other tax model, logic, and functionality as discussed herein, and/or as known in the art at the time of filing, and/or as developed after the time of filing.

As seen in FIG. 3, tax model global ready financial asset 354 includes regionally optimized tax model, logic, and functionality for India 453 to provide the tax model, logic, and functionality to any of global ready financial applications 107 for India.

Likewise, tax model global ready financial asset 354 includes regionally optimized identity model, logic, and functionality for the United States (US) 553 to provide the tax model, logic, and functionality to any of global ready financial applications 107 for the US.

Likewise, tax model global ready financial asset 354 includes regionally optimized tax model, logic, and functionality for the United Kingdom (UK) 653 to provide the identity model, logic, and functionality to any of global ready financial applications 107 for the UK.

Those of skill in the art will readily recognize that while only three examples of regionally optimized identity model, logic, and functionality are shown for tax model global ready financial asset 354, i.e., India 453, US 553, and UK 653, numerous other regionally optimized identity model, logic, and functionality for numerous other regions can be provided in various other embodiments.

Referring to FIG. 3, as a specific illustrative example, in one embodiment, global ready financial assets 157 include, but are not limited to, a payment gateway global ready financial asset 356 to provide the localized payment gateway model, logic, and functionality to be used by global ready financial applications 107 in various regions of the two or more supported regions.

As seen in FIG. 3, payment gateway global ready financial asset 356 includes regionally optimized payment gateway model, logic, and functionality for India 455 to provide the payment gateway model, logic, and functionality to any of global ready financial applications 107 for India.

Likewise, payment gateway global ready financial asset 356 includes regionally optimized payment gateway model, logic, and functionality for the United States (US) 555 to provide the payment gateway model, logic, and functionality to any of global ready financial applications 107 for the US.

Likewise, payment gateway global ready financial asset 356 includes regionally optimized payment gateway model, logic, and functionality for the United Kingdom (UK) 655 to provide the payment gateway model, logic, and functionality to any of global ready financial applications 107 for the UK.

Those of skill in the art will readily recognize that while only three examples of regionally optimized payment gateway model, logic, and functionality are shown for payment gateway global ready financial asset 356, i.e., India 455, US 555, and UK 655, numerous other regionally optimized payment gateway model, logic, and functionality for numerous other regions can be provided in various other embodiments.

Referring to FIG. 3, as a specific illustrative example, in one embodiment, global ready financial assets 157 include, but are not limited to, a billing global ready financial asset 357 to provide the billing and payment model, logic, and functionality to be used by global ready financial applications 107 in various regions of the two or more supported regions, e.g., the revenue recognition model, logic, and functionality for various regions of the two or more supported regions; the billing regulations and procedures model, logic, and functionality for various regions of the two or more supported regions; and/or any other billing and payment model, logic, and functionality as discussed herein, and/or as known in the art at the time of filing, and/or as becomes known after the time of filing.

As seen in FIG. 3, billing global ready financial asset 357 includes regionally optimized billing model, logic, and functionality for India 457 to provide the identity model, logic, and functionality to any of global ready financial applications 107 for India.

Likewise, billing global ready financial asset 357 includes regionally optimized billing model, logic, and functionality for the United States (US) 557 to provide the billing model, logic, and functionality to any of global ready financial applications 107 for the US.

Likewise, billing global ready financial asset 357 includes regionally optimized billing model, logic, and functionality for the United Kingdom (UK) 657 to provide the identity model, logic, and functionality to any of global ready financial applications 107 for the UK.

Those of skill in the art will readily recognize that while only three examples of regionally optimized billing model, logic, and functionality are shown for billing global ready financial asset 357, i.e., India 457, US 557, and UK 657, numerous other regionally optimized billing model, logic, and functionality for numerous other regions can be provided in various other embodiments.

Referring to FIG. 3, as a specific illustrative example, in one embodiment, global ready financial assets 157 include, but are not limited to, a bank feeds global ready financial asset 358 to provide the bank feed model, logic, and functionality to global ready financial applications 107 for various regions of the two or more supported regions; the data movement model, logic, and functionality to global ready financial applications 107 for various regions of the two or more supported regions; and/or any other bank feed model, logic, and functionality as discussed herein, and/or as known in the art at the time of filing, and/or as becomes known after the time of filing.

As seen in FIG. 3, bank feeds global ready financial asset 358 includes regionally optimized bank feeds model, logic, and functionality for India 459 to provide the bank feeds model, logic, and functionality to any of global ready financial applications 107 for India.

Likewise, bank feeds global ready financial asset 358 includes regionally optimized bank feeds model, logic, and functionality for the United States (US) 559 to provide the bank feeds model, logic, and functionality to any of global ready financial applications 107 for the US.

Likewise, bank feeds global ready financial asset 358 includes regionally optimized bank feeds model, logic, and functionality for the United Kingdom (UK) 659 to provide the bank feeds model, logic, and functionality to any of global ready financial applications 107 for the UK.

Those of skill in the art will readily recognize that while only three examples of regionally optimized bank feeds model, logic, and functionality are shown for bank feeds global ready financial asset 358, i.e., India 459, US 559, and UK 659, numerous other regionally optimized bank feeds model, logic, and functionality for numerous other regions can be provided in various other embodiments.

Referring to FIG. 3, as a specific illustrative example, in one embodiment, global ready financial assets 157 include, but are not limited to, a currency conversion global ready financial asset 340 to provide the local currency model, logic, and functionality for various regions of the two or more supported regions; and/or the currency conversion model, logic, and functionality for the global ready financial applications for various regions of the two or more supported regions.

In one embodiment, global ready financial assets 157 include, but are not limited to, other global ready financial assets not shown in FIG. 3 such as a user contribution and/or local templates global ready financial asset to provide the personalized service model, logic, and/or functionality for the global ready financial applications for various regions of the two or more supported regions; the user customizations and template sharing data, logic, and functionality for the global ready financial applications for various regions of the two or more supported regions; and/or any other personalized service model, logic, and/or functionality discussed herein, and/or as known in the art at the time of filing, and/or as developed/becomes known after the time of filing.

In one embodiment, global ready financial assets 157 include, but are not limited to, any combination of the global ready financial assets discussed herein, or any other global ready financial assets desired, and/or as known in the art at the time of filing, and/or as developed/becomes known after the time of filing.

In one embodiment, once global ready financial assets are pre-created, pre-deployed, and/or provided, that include regionally optimized business, legal, and operational models, logic, data, and/or functionality for two or more supported regions for use by the global ready financial applications, at PROVIDE ONE OR MORE GLOBAL READY FINANCIAL ASSETS, EACH OF THE ONE OR MORE GLOBAL READY FINANCIAL ASSETS INCLUDING REGIONALLY OPTIMIZED LOGIC FOR PROVIDING REGIONALLY OPTIMIZED MODELING AND FUNCTIONALITY ASSOCIATED WITH THAT TYPE OF GLOBAL READY FINANCIAL ASSET OPERATION 203, process flow proceeds to PROVIDE A GLOBAL READY FINANCIAL APPLICATION OPERATION 205.

In one embodiment, at PROVIDE A GLOBAL READY FINANCIAL APPLICATION OPERATION 205 access to one or more global ready financial applications is provided to a user.

FIG. 3 is a block diagram showing the relationship between global ready financial applications 107 of FIGS. 1 and 3, and global ready financial assets 157 of FIGS. 1 and 3 in accordance with one embodiment. Referring to FIG. 3, exemplary global ready financial applications 107 include a Profit and Loss (P&L) global ready financial application 301 for generating P&L reports; reports global ready financial application 303 for generating various customized financial reports; tax global ready financial application 305 for generating and/or filing tax documents; payroll global ready financial application 307 for generating payrolls; banking global ready financial application 309 for providing on-line bank reports and data; invoice global ready financial application 311 for generating invoices; and general application 313 representing any global ready financial application as discussed herein, and/or as known in the art at the time of filing, and/or as developed, or becomes known, after the time of filing.

In one embodiment, once access to one or more global ready financial applications is made available to a user at PROVIDE A GLOBAL READY FINANCIAL APPLICATION OPERATION 205, process flow proceeds to A USER ACCESSES THE GLOBAL READY FINANCIAL APPLICATION OPERATION 207.

In one embodiment, at A USER ACCESSES THE GLOBAL READY FINANCIAL APPLICATION OPERATION 207 a user accesses one of the one or more global ready financial applications of PROVIDE A GLOBAL READY FINANCIAL APPLICATION OPERATION 205.

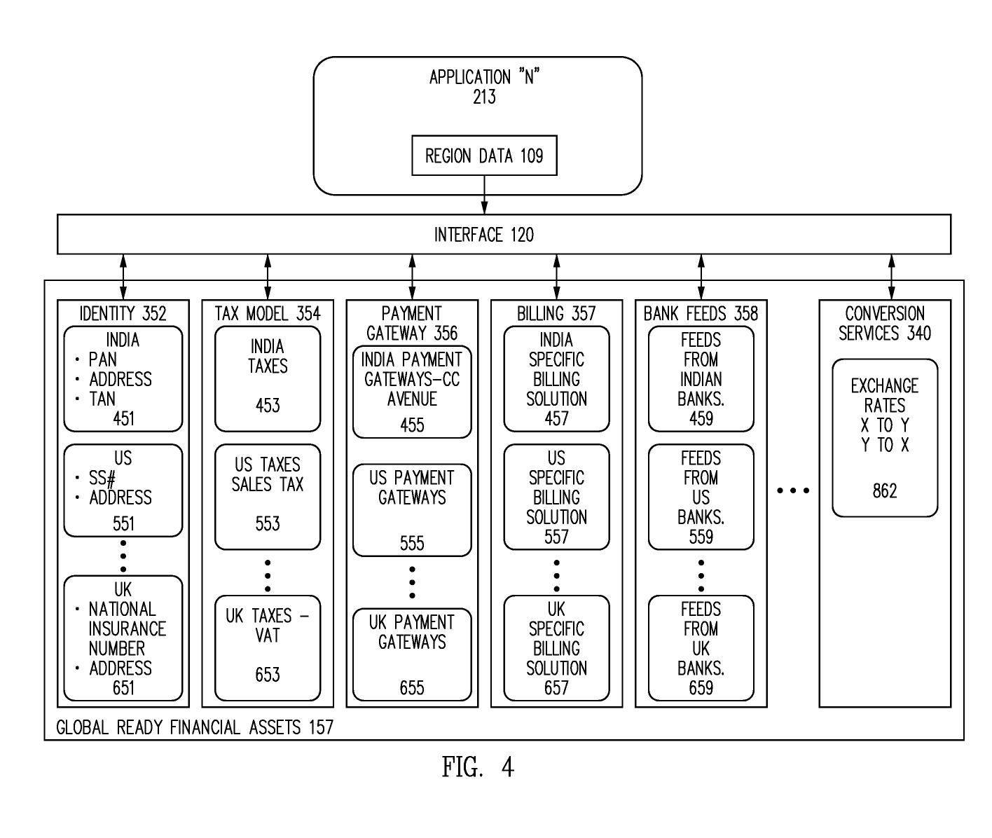

FIG. 4 is a block diagram showing the relationship between a given selected global ready financial application, application “N” 213 of FIG. 3, and global ready financial assets 157 in accordance with one embodiment. Global ready financial assets 157 are discussed in detail above with respect to FIG. 3. In this specific instance, application “N” 213 has been selected by the user at A USER ACCESSES THE GLOBAL READY FINANCIAL APPLICATION OPERATION 207.

Returning to FIG. 2, in one embodiment, once a user accesses one of the one or more global ready financial applications of PROVIDE A GLOBAL READY FINANCIAL APPLICATION OPERATION 205 at A USER ACCESSES THE GLOBAL READY FINANCIAL APPLICATION OPERATION 207, process flow proceeds to DETERMINE A REGION ASSOCIATED WITH THE USER OPERATION 209.

In one embodiment, at DETERMINE A REGION ASSOCIATED WITH THE USER OPERATION 209 a region to be associated with the user accessing one of the one or more global ready financial applications of A USER ACCESSES THE GLOBAL READY FINANCIAL APPLICATION OPERATION 207, and the eventual global ready financial application instance, is determined.

In one embodiment, at DETERMINE A REGION ASSOCIATED WITH THE USER OPERATION 209 the region to be associated with the user and the eventual global ready financial application instance is obtained from one or more sources.

In one embodiment, at DETERMINE A REGION ASSOCIATED WITH THE USER OPERATION 209 the region to be associated with the user and the eventual global ready financial application instance is determined, at least in part, based on an IP address associated with a computing system used by the party accessing the global ready financial application.

As persons of ordinary skill will readily appreciate, an IP address is typically assigned to a computing system, by a network or other communication channel the computing system is using, and the assigned IP address often has numerical similarities with other computing systems located nearby on the same network. In one embodiment, in the case of the computing system being coupled to a public network through a private network, as one example, either of a private network IP address associated with the computing system or a public network IP address represented in network communication of the computing system may be used, at least in part, to determine the region to be associated with a given global ready financial application instance.

In one embodiment, at DETERMINE A REGION ASSOCIATED WITH THE USER OPERATION 209 the region to be associated with the user and the eventual global ready financial application instance is determined, at least in part, based on local, language, or other information received as part of the request to access the global ready financial application, such as a locale indicator provided by a web browser application being used by the user.

In one embodiment, at DETERMINE A REGION ASSOCIATED WITH THE USER OPERATION 209 the region to be associated with the user and the eventual global ready financial application instance is determined, at least in part, based on user profile data or other information provided by a user of the global ready financial application. For example, the initial determination of a geographic location may be made after the user is recognized as an authorized user, or at any time appropriate.

In one embodiment, at DETERMINE A REGION ASSOCIATED WITH THE USER OPERATION 209 the region to be associated with the user and the eventual global ready financial application instance is determined by any method, means, process, and/or procedure, as discussed herein, and/or as known in the at the time of filing, and/or as developed/made available after the time of filing.

As noted above, FIG. 4 is a block diagram showing the relationship between a given selected global ready financial application, application “N” 213 in FIG. 3, and global ready financial assets 157 in accordance with one embodiment. Global ready financial assets 157 are discussed in detail above with respect to FIG. 3. In this specific instance, application “N” 213 has been selected by the user at A USER ACCESSES THE GLOBAL READY FINANCIAL APPLICATION OPERATION 207 and includes region data 109 indicating a region to be associated with the user accessing application “N” 213. In one embodiment, region data 109 is provided to global ready financial assets 157 via interface 120.

In one embodiment, once a region to be associated with the user accessing one of the one or more global ready financial applications of A USER ACCESSES THE GLOBAL READY FINANCIAL APPLICATION OPERATION 207, and the eventual global ready financial application instance, is determined at DETERMINE A REGION ASSOCIATED WITH THE USER OPERATION 209, process flow proceeds to ACCESS THE ONE OR MORE GLOBAL READY FINANCIAL ASSETS OPERATION 211.

In one embodiment, at ACCESS THE ONE OR MORE GLOBAL READY FINANCIAL ASSETS OPERATION 211 access to the global ready financial assets is provided through an interface between the global ready financial application instance of A USER ACCESSES THE GLOBAL READY FINANCIAL APPLICATION OPERATION 207 and the global ready financial assets of PROVIDE ONE OR MORE GLOBAL READY FINANCIAL ASSETS, EACH OF THE ONE OR MORE GLOBAL READY FINANCIAL ASSETS INCLUDING REGIONALLY OPTIMIZED LOGIC FOR PROVIDING REGIONALLY OPTIMIZED MODELING AND FUNCTIONALITY ASSOCIATED WITH THAT TYPE OF GLOBAL READY FINANCIAL ASSET OPERATION 203.

In one embodiment, the interface between the global ready financial application instance of A USER ACCESSES THE GLOBAL READY FINANCIAL APPLICATION OPERATION 207 and the global ready financial assets of PROVIDE ONE OR MORE GLOBAL READY FINANCIAL ASSETS, EACH OF THE ONE OR MORE GLOBAL READY FINANCIAL ASSETS INCLUDING REGIONALLY OPTIMIZED LOGIC FOR PROVIDING REGIONALLY OPTIMIZED MODELING AND FUNCTIONALITY ASSOCIATED WITH THAT TYPE OF GLOBAL READY FINANCIAL ASSET OPERATION 203 is an Application Program Interface (API) or any other interface, or user interface, as discussed herein, and/or as known in the art at the time of filing, and/or as developed/becomes known after the time of filing.

As noted above, FIG. 4 is a block diagram showing the relationship between a given selected global ready financial application, application “N” 213 in FIG. 3, and global ready financial assets 157 in accordance with one embodiment. Global ready financial assets 157 are discussed in detail above with respect to FIG. 3. In this specific instance, application “N” 213 has been selected by the user at A USER ACCESSES THE GLOBAL READY FINANCIAL APPLICATION OPERATION 207 and includes region data 109 indicating a region to be associated with the user accessing application “N” 213. In one embodiment, global ready financial assets 157 are accessed via interface 120.

In one embodiment, once access to the global ready financial assets is provided through an interface between the global ready financial application instance of A USER ACCESSES THE GLOBAL READY FINANCIAL APPLICATION OPERATION 207 and the global ready financial assets of PROVIDE ONE OR MORE GLOBAL READY FINANCIAL ASSETS, EACH OF THE ONE OR MORE GLOBAL READY FINANCIAL ASSETS INCLUDING REGIONALLY OPTIMIZED LOGIC FOR PROVIDING REGIONALLY OPTIMIZED MODELING AND FUNCTIONALITY ASSOCIATED WITH THAT TYPE OF GLOBAL READY FINANCIAL ASSET OPERATION 203 at ACCESS THE ONE OR MORE GLOBAL READY FINANCIAL ASSETS OPERATION 211, process flow proceeds to USE THE ONE OR MORE GLOBAL READY FINANCIAL ASSETS TO COMPOSE A REGIONALLY OPTIMIZED GLOBAL READY FINANCIAL APPLICATION THAT IS OPTIMIZED FOR THE DETERMINED REGION ASSOCIATED WITH THE USER OPERATION 213.

In one embodiment, at USE THE ONE OR MORE GLOBAL READY FINANCIAL ASSETS TO COMPOSE A REGIONALLY OPTIMIZED GLOBAL READY FINANCIAL APPLICATION THAT IS OPTIMIZED FOR THE DETERMINED REGION ASSOCIATED WITH THE USER OPERATION 213 once the region to be associated with a given global ready financial application instance is determined at DETERMINE A REGION ASSOCIATED WITH THE USER OPERATION 209, and the required global ready financial assets are accessed at ACCESS THE ONE OR MORE GLOBAL READY FINANCIAL ASSETS OPERATION 211, a regionally optimized global ready financial application instance for the region associated with the user of DETERMINE A REGION ASSOCIATED WITH THE USER OPERATION 209 is automatically composed using the relevant portions of the global ready financial assets for the determined region.

As noted above, FIG. 4 is a block diagram showing the relationship between a given selected global ready financial application, application “N” 213 in FIG. 3, and global ready financial assets 157 in accordance with one embodiment. Global ready financial assets 157 are discussed in detail above with respect to FIG. 3. In this specific instance, application “N” 213 has been selected by the user at A USER ACCESSES THE GLOBAL READY FINANCIAL APPLICATION OPERATION 207 and includes region data 109 indicating a region to be associated with the user accessing application “N” 213. In one embodiment, global ready financial assets 157 are accessed via interface 120.

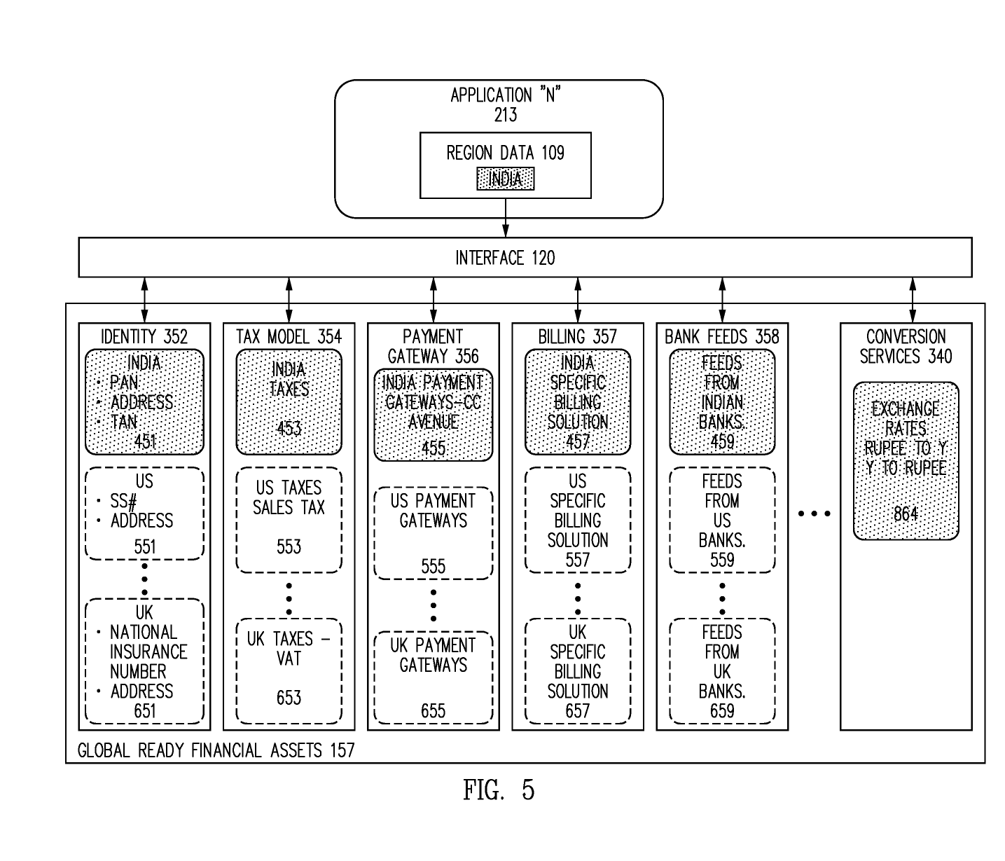

FIG. 5 is a block diagram showing the relationship between a given selected global ready financial application, application “N” 213 in FIG. 3, and global ready financial assets 157 in accordance with one embodiment when the region data 109 indicates the region associated with the user is India.

As seen in FIG. 5, given that, in this instance, region data 109 indicates the region associated with the user is India: regionally optimized identity model, logic, and functionality for India 451 of identity global ready financial asset 352 is utilized to compose application “N” 213; regionally optimized tax model, logic, and functionality for India 453 of tax model global ready financial asset 354 is utilized to compose application “N” 213; regionally optimized payment gateway model, logic, and functionality for India 455 of payment gateway global ready financial asset 356 is utilized to compose application “N” 213; regionally optimized billing model, logic, and functionality for India 457 of billing global ready asset 357 is utilized to compose application “N” 213; regionally optimized bank feeds model, logic, and functionality for India 459 of bank feeds global ready asset 358 is utilized to compose application “N” 213; and currency conversion global ready financial asset 340 is used to provide the local currency model, logic, and functionality module 864 for India and to compose application “N” 213.

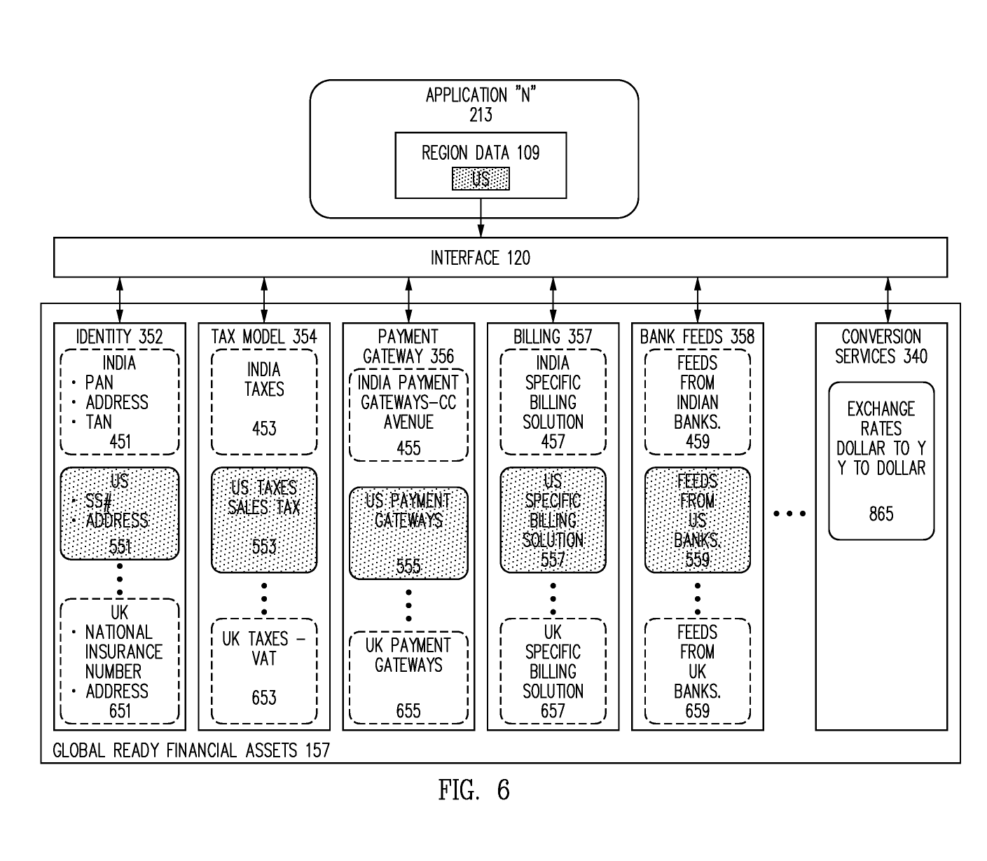

FIG. 6 is a block diagram showing the relationship between a given selected global ready financial application, application “N” 213 in FIG. 3, and global ready financial assets 157 in accordance with one embodiment when the region data 109 indicates the region associated with the user is the United States (US).

As seen in FIG. 6, given that, in this instance, region data 109 indicates the region associated with the user is the United States: regionally optimized identity model, logic, and functionality for US 551 of identity global ready financial asset 352 is utilized to compose application “N” 213; regionally optimized tax model, logic, and functionality for the US 553 of tax model global ready financial asset 354 is utilized to compose application “N” 213; regionally optimized payment gateway model, logic, and functionality for the US 555 of payment gateway global ready financial asset 356 is utilized to compose application “N” 213; regionally optimized billing model, logic, and functionality for the US 557 of billing global ready asset 357 is utilized to compose application “N” 213; regionally optimized bank feeds model, logic, and functionality for the US 559 of bank feeds global ready asset 358 is utilized to compose application “N” 213; and currency conversion global ready financial asset 340 is used to provide the local currency model, logic, and functionality module 865 for the US and to compose application “N” 213.

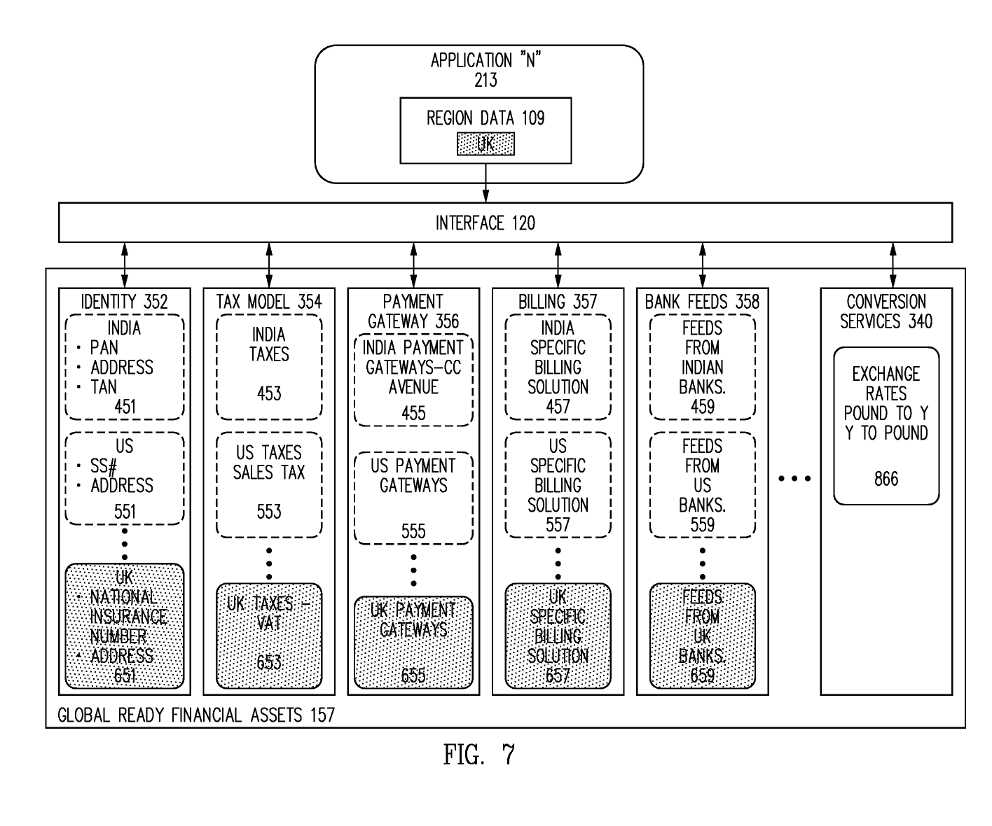

FIG. 7 is a block diagram showing the relationship between a given selected global ready financial application, application “N” 213 in FIG. 3, and global ready financial assets 157 in accordance with one embodiment when the region data 109 indicates the region associated with the user is the United Kingdom (UK).

As seen in FIG. 7, given that, in this instance, region data 109 indicates the region associated with the user is the United Kingdom: regionally optimized identity model, logic, and functionality for UK 651 of identity global ready financial asset 352 is utilized to compose application “N” 213; regionally optimized tax model, logic, and functionality for the UK 653 of tax model global ready financial asset 354 is utilized to compose application “N” 213; regionally optimized payment gateway model, logic, and functionality for the UK 655 of payment gateway global ready financial asset 356 is utilized to compose application “N” 213; regionally optimized billing model, logic, and functionality for the UK 657 of billing global ready asset 357 is utilized to compose application “N” 213; regionally optimized bank feeds model, logic, and functionality for the UK 659 of bank feeds global ready asset 358 is utilized to compose application “N” 213; and currency conversion global ready financial asset 340 is used to provide the local currency model, logic, and functionality module 866 for the UK and to compose application “N” 213.

In one embodiment, once a regionally optimized global ready financial application instance for the region associated with the user of DETERMINE A REGION ASSOCIATED WITH THE USER OPERATION 209 is automatically composed using the relevant portions of the global ready financial assets for the determined region at USE THE ONE OR MORE GLOBAL READY FINANCIAL ASSETS TO COMPOSE A REGIONALLY OPTIMIZED GLOBAL READY FINANCIAL APPLICATION THAT IS OPTIMIZED FOR THE DETERMINED REGION ASSOCIATED WITH THE USER OPERATION 213, process flow proceeds to PROVIDE THE USER ACCESS TO THE REGIONALLY OPTIMIZED GLOBAL READY FINANCIAL APPLICATION FOR THE DETERMINED REGION ASSOCIATED WITH THE USER OPERATION 215.

In one embodiment, at PROVIDE THE USER ACCESS TO THE REGIONALLY OPTIMIZED GLOBAL READY FINANCIAL APPLICATION FOR THE DETERMINED REGION ASSOCIATED WITH THE USER OPERATION 215 the regionally optimized global ready financial application instance for the region associated with the user of DETERMINE A REGION ASSOCIATED WITH THE USER OPERATION 209 of USE THE ONE OR MORE GLOBAL READY FINANCIAL ASSETS TO COMPOSE A REGIONALLY OPTIMIZED GLOBAL READY FINANCIAL APPLICATION THAT IS OPTIMIZED FOR THE DETERMINED REGION ASSOCIATED WITH THE USER OPERATION 213 is provided to the user and used to perform the regionally optimized global ready financial applications' core function and service for the determined region associated with the user.

In one embodiment, once the regionally optimized global ready financial application instance for the region associated with the user of DETERMINE A REGION ASSOCIATED WITH THE USER OPERATION 209 of USE THE ONE OR MORE GLOBAL READY FINANCIAL ASSETS TO COMPOSE A REGIONALLY OPTIMIZED GLOBAL READY FINANCIAL APPLICATION THAT IS OPTIMIZED FOR THE DETERMINED REGION ASSOCIATED WITH THE USER OPERATION 213 is provided to the user and used to perform the regionally optimized global ready financial applications' core function and service for the determined region associated with the user at PROVIDE THE USER ACCESS TO THE REGIONALLY OPTIMIZED GLOBAL READY FINANCIAL APPLICATION FOR THE DETERMINED REGION ASSOCIATED WITH THE USER OPERATION 215, process flow proceeds to EXIT OPERATION 230.

In one embodiment, at EXIT OPERATION 230 process 200 for providing global ready financial applications is exited to await new data.

Using process 200 for providing global ready financial applications, a single global ready financial application, once created, can be operationally and functionally optimized for multiple supported regions to be used by any party, in any, or all, of the multiple supported regions.

In addition, once created and provided, the global ready financial assets of PROVIDE ONE OR MORE GLOBAL READY FINANCIAL ASSETS, EACH OF THE ONE OR MORE GLOBAL READY FINANCIAL ASSETS INCLUDING REGIONALLY OPTIMIZED LOGIC FOR PROVIDING REGIONALLY OPTIMIZED MODELING AND FUNCTIONALITY ASSOCIATED WITH THAT TYPE OF GLOBAL READY FINANCIAL ASSET OPERATION 203 can be used to compose multiple types of global ready financial applications, such as global ready financial applications 107 of FIG. 3.

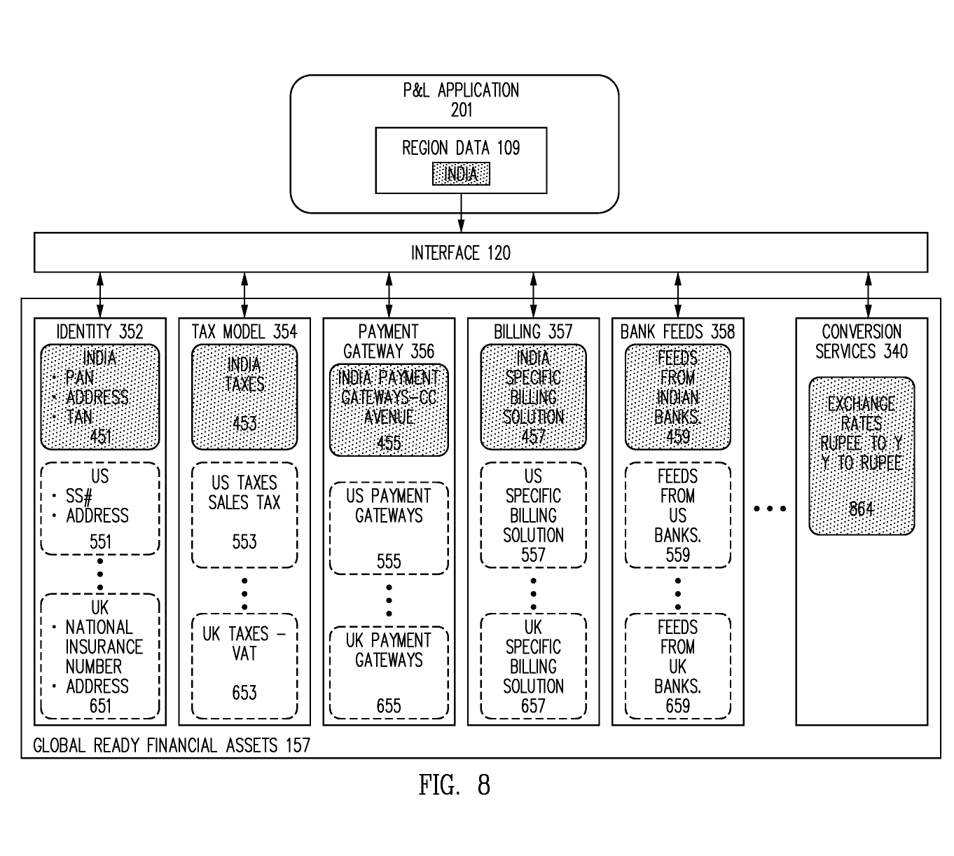

As a specific example, FIG. 8 is a block diagram showing the relationship between a given selected profit and loss report generation global ready financial application, P&L application 201 of FIG. 3, and global ready financial assets 157 in accordance with one embodiment when the region data 109 indicates the region associated with the user is India.

As seen in FIG. 8, given that, in this instance, region data 109 indicates the region associated with the user is India: regionally optimized identity model, logic, and functionality for India 451 of identity global ready financial asset 352 is utilized to compose P&L application 201; regionally optimized tax model, logic, and functionality for India 453 of tax model global ready financial asset 354 is utilized to compose P&L application 201; regionally optimized payment gateway model, logic, and functionality for India 455 of payment gateway global ready financial asset 356 is utilized to compose P&L application 201; regionally optimized billing model, logic, and functionality for India 457 of billing global ready asset 357 is utilized to compose P&L application 201; regionally optimized bank feeds model, logic, and functionality for India 459 of bank feeds global ready asset 358 is utilized to compose P&L application 201; and currency conversion global ready financial asset 340 is used to provide the local currency model, logic, and functionality module 864 for India and to compose P&L application 201.

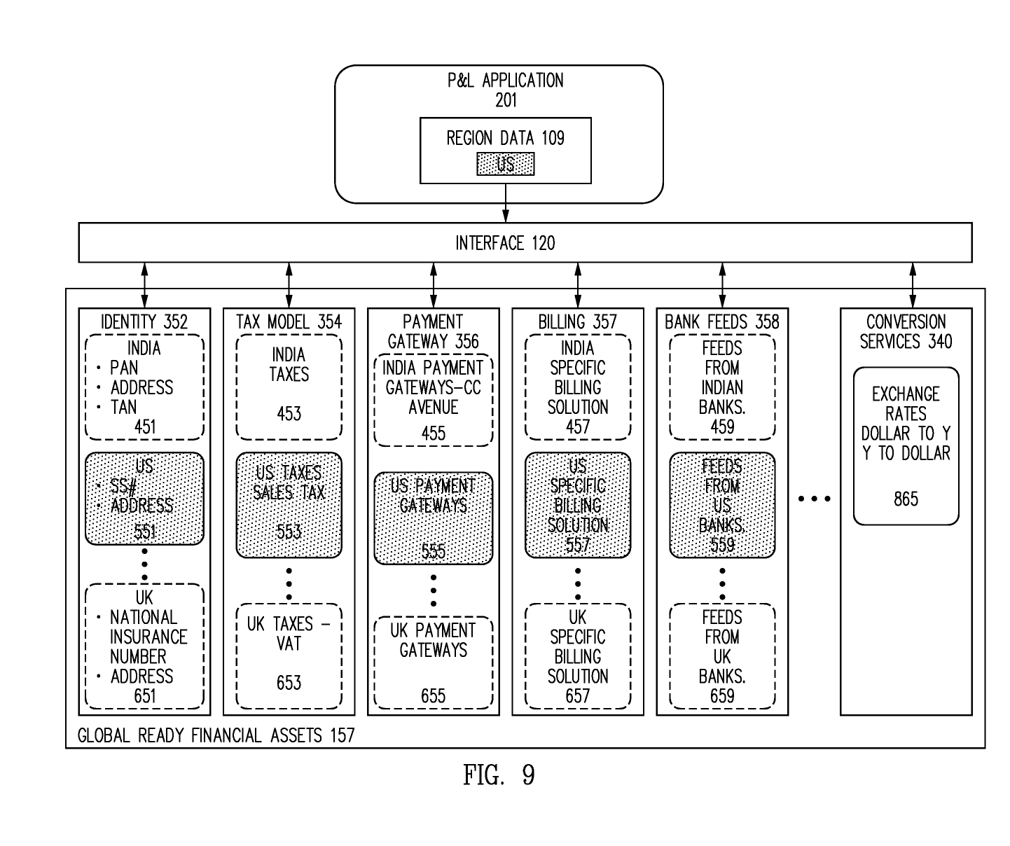

FIG. 9 is a block diagram showing the relationship between P&L application 201 and global ready financial assets 157 in accordance with one embodiment when the region data 109 indicates the region associated with the user is the United States (US).

As seen in FIG. 9, given that, in this instance, region data 109 indicates the region associated with the user is the United States: regionally optimized identity model, logic, and functionality for US 551 of identity global ready financial asset 352 is utilized to compose P&L application 201; regionally optimized tax model, logic, and functionality for the US 553 of tax model global ready financial asset 354 is utilized to compose P&L application 201; regionally optimized payment gateway model, logic, and functionality for the US 555 of payment gateway global ready financial asset 356 is utilized to compose P&L application 201; regionally optimized billing model, logic, and functionality for the US 557 of billing global ready asset 357 is utilized to compose P&L application 201; regionally optimized bank feeds model, logic, and functionality for the US 559 of bank feeds global ready asset 358 is utilized to compose P&L application 201; and currency conversion global ready financial asset 340 is used to provide the local currency model, logic, and functionality module 865 for the US and to compose P&L application 201.

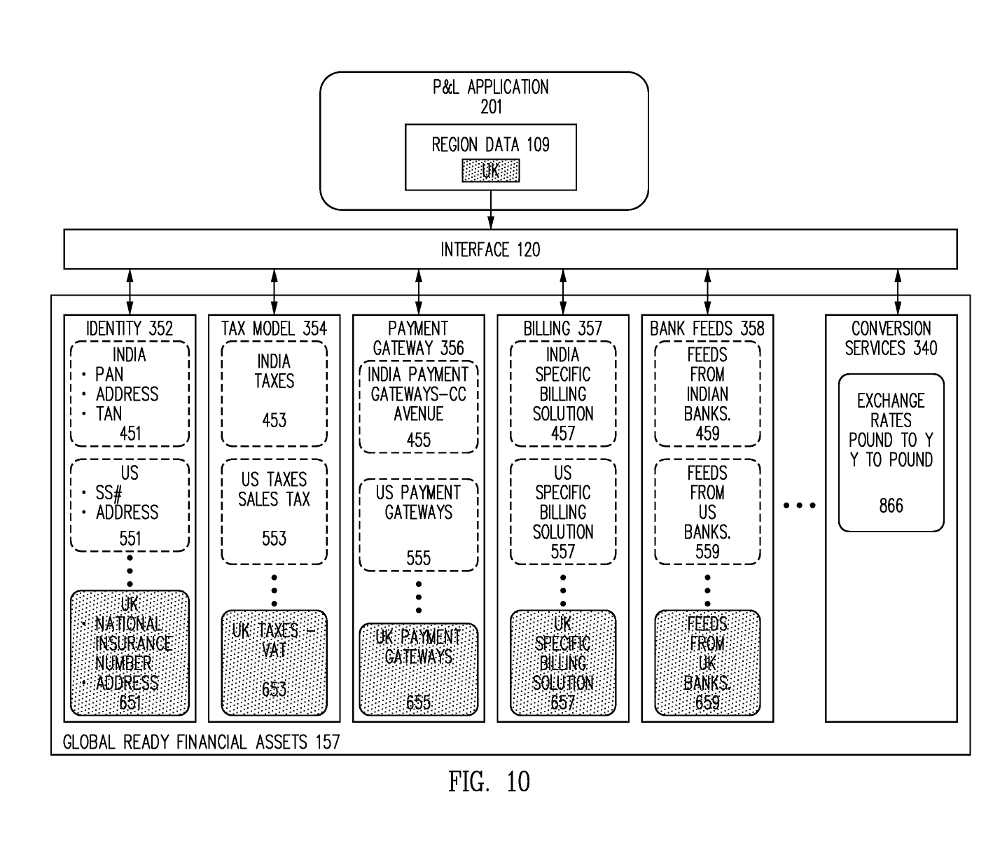

FIG. 10 is a block diagram showing the relationship between P&L application 201 and global ready financial assets 157 in accordance with one embodiment when the region data 109 indicates the region associated with the user is the United Kingdom (UK).

As seen in FIG. 10, given that, in this instance, region data 109 indicates the region associated with the user is the United Kingdom: regionally optimized identity model, logic, and functionality for UK 651 of identity global ready financial asset 352 is utilized to compose P&L application 201; regionally optimized tax model, logic, and functionality for the UK 653 of tax model global ready financial asset 354 is utilized to compose P&L application 201; regionally optimized payment gateway model, logic, and functionality for the UK 655 of payment gateway global ready financial asset 356 is utilized to compose P&L application 201; regionally optimized billing model, logic, and functionality for the UK 657 of billing global ready asset 357 is utilized to compose P&L application 201; regionally optimized bank feeds model, logic, and functionality for the UK 659 of bank feeds global ready asset 358 is utilized to compose P&L application 201; and currency conversion global ready financial asset 340 is used to provide the local currency model, logic, and functionality module 866 for the UK and to compose P&L application 201.

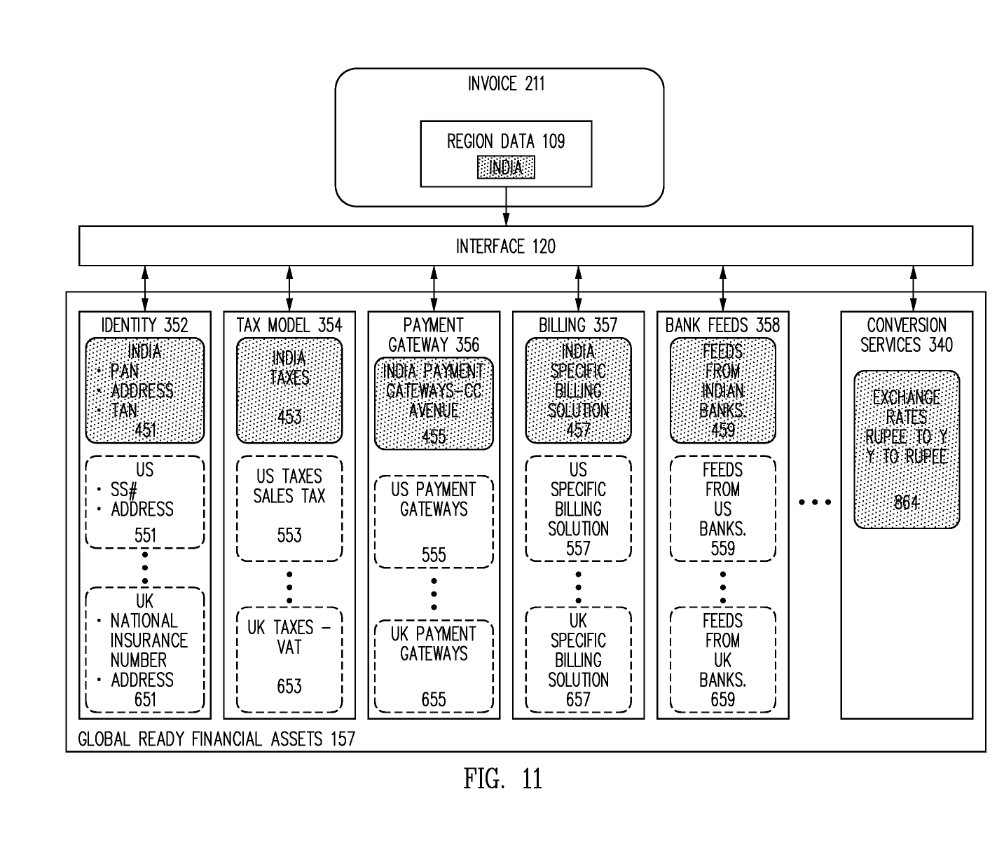

As another specific example, FIG. 11 is a block diagram showing the relationship between a given selected invoice generation global ready financial application, invoice application 211 of FIG. 3, and global ready financial assets 157 in accordance with one embodiment when the region data 109 indicates the region associated with the user is India.

As seen in FIG. 11, given that, in this instance, region data 109 indicates the region associated with the user is India: regionally optimized identity model, logic, and functionality for India 451 of identity global ready financial asset 352 is utilized to compose invoice application 211; regionally optimized tax model, logic, and functionality for India 453 of tax model global ready financial asset 354 is utilized to compose invoice application 211; regionally optimized payment gateway model, logic, and functionality for India 455 of payment gateway global ready financial asset 356 is utilized to compose invoice application 211; regionally optimized billing model, logic, and functionality for India 457 of billing global ready asset 357 is utilized to compose invoice application 211; regionally optimized bank feeds model, logic, and functionality for India 459 of bank feeds global ready asset 358 is utilized to compose invoice application 211; and currency conversion global ready financial asset 340 is used to provide the local currency model, logic, and functionality module 864 for India and to compose invoice application 211.

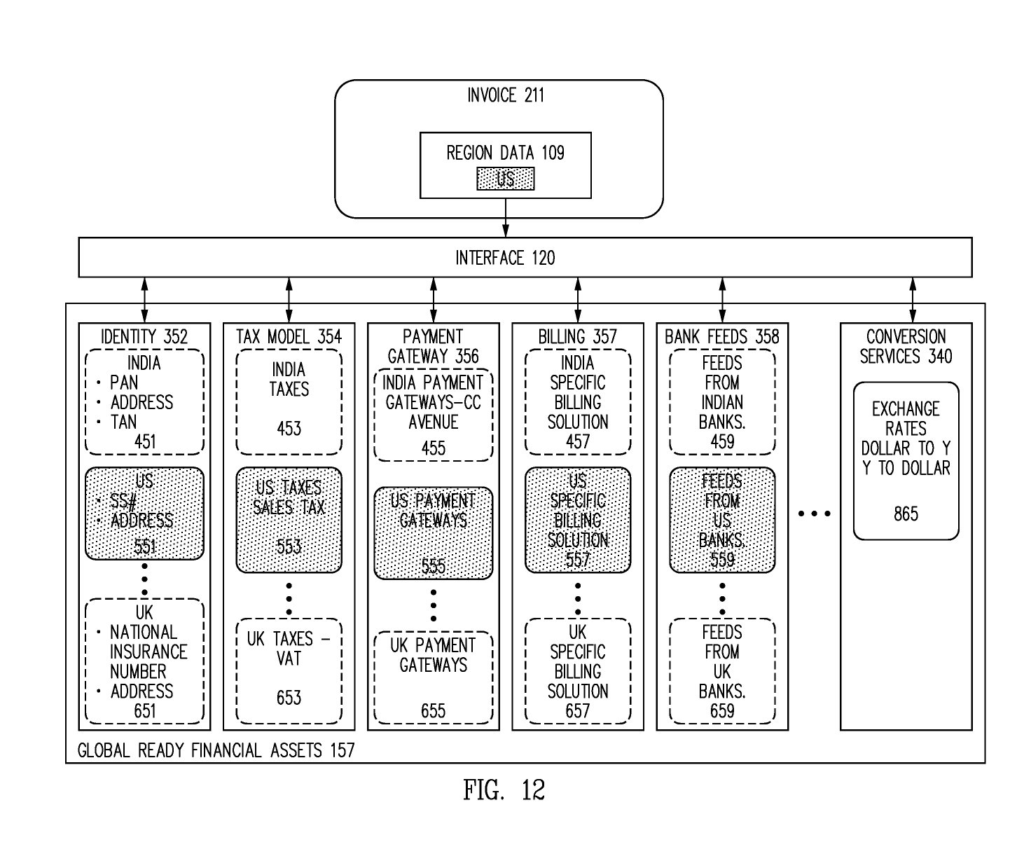

FIG. 12 is a block diagram showing the relationship between invoice application 211 and global ready financial assets 157 in accordance with one embodiment when the region data 109 indicates the region associated with the user is the United States (US).

As seen in FIG. 12, given that, in this instance, region data 109 indicates the region associated with the user is the United States: regionally optimized identity model, logic, and functionality for US 551 of identity global ready financial asset 352 is utilized to compose invoice application 211; regionally optimized tax model, logic, and functionality for the US 553 of tax model global ready financial asset 354 is utilized to compose invoice application 211; regionally optimized payment gateway model, logic, and functionality for the US 555 of payment gateway global ready financial asset 356 is utilized to compose invoice application 211; regionally optimized billing model, logic, and functionality for the US 557 of billing global ready asset 357 is utilized to compose invoice application 211; regionally optimized bank feeds model, logic, and functionality for the US 559 of bank feeds global ready asset 358 is utilized to compose invoice application 211; and currency conversion global ready financial asset 340 is used to provide the local currency model, logic, and functionality module 865 for the US and to compose invoice application 211.

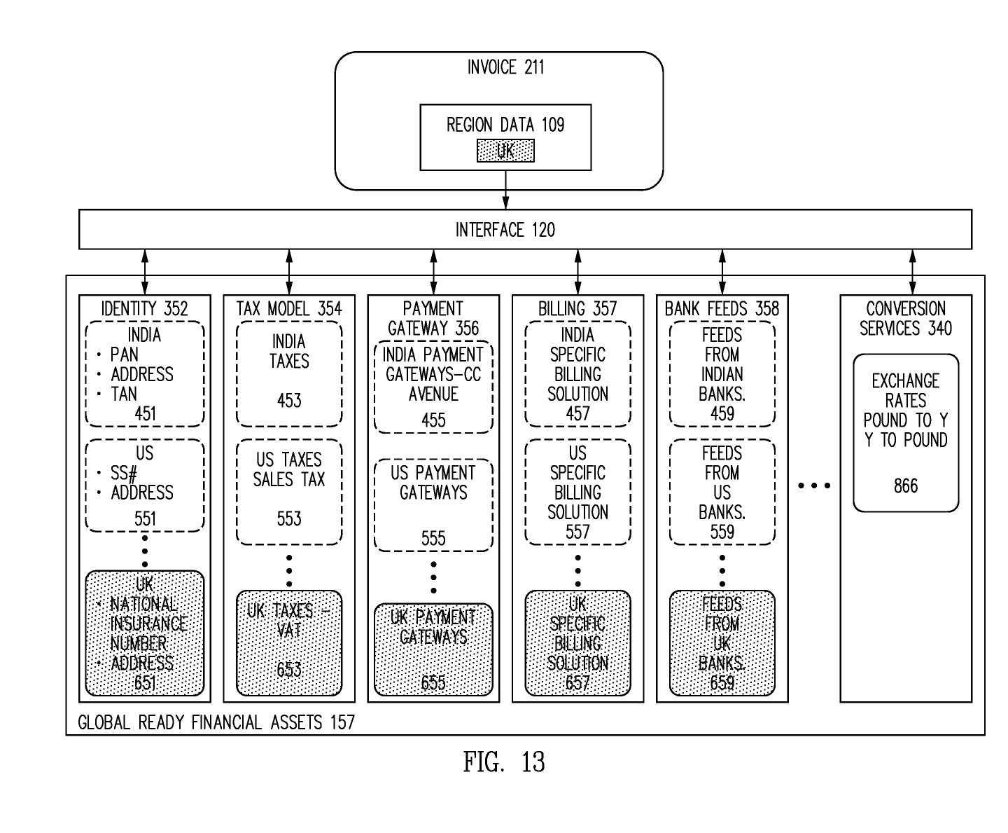

FIG. 13 is a block diagram showing the relationship between invoice application 211 and global ready financial assets 157 in accordance with one embodiment when the region data 109 indicates the region associated with the user is the United Kingdom (UK).

As seen in FIG. 13, given that, in this instance, region data 109 indicates the region associated with the user is the United Kingdom: regionally optimized identity model, logic, and functionality for UK 651 of identity global ready financial asset 352 is utilized to compose invoice application 211; regionally optimized tax model, logic, and functionality for the UK 653 of tax model global ready financial asset 354 is utilized to compose invoice application 211; regionally optimized payment gateway model, logic, and functionality for the UK 655 of payment gateway global ready financial asset 356 is utilized to compose invoice application 211; regionally optimized billing model, logic, and functionality for the UK 657 of billing global ready asset 357 is utilized to compose invoice application 211; regionally optimized bank feeds model, logic, and functionality for the UK 659 of bank feeds global ready asset 358 is utilized to compose invoice application 211; and currency conversion global ready financial asset 340 is used to provide the local currency model, logic, and functionality module 866 for the UK and to compose invoice application 211.

Those of skill in the art will readily recognize that while only three examples of regions, i.e., India, the United States, and the United Kingdom, as discussed above with respect to FIGS. 4, 5, 6, 7, 8, 9, 10, 11, 12, and 13, any specific regions, and/or any number of regions can be supported in various other embodiments.

Similarly, while only two specific examples of global ready financial applications, i.e., P&L application 201 and invoice application 211, were discussed above with respect to FIGS. 8, 9, and 10, and FIGS. 11, 12, and 13, respectively, any type of global ready financial application, and/or number of different types of global ready financial applications can be composed in various embodiments.

Using process 200 for providing global ready financial applications discussed above, global ready financial applications are provided that are dynamically composed using global ready financial assets. As a result, global ready financial applications are provided that are automatically regionally optimized in both form and function based on a determined region to be associated with specific instances of the global ready financial applications. In this way a single global ready financial application can be dynamically optimized for multiple supported regions and used by any party in multiple supported regions without having to create separate regionally optimized versions of the global ready financial application for each region.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for providing global ready financial applications comprising the following, which when executed individually or collectively by any set of one or more processors perform a process including:
providing one or more global ready financial assets, each of the one or more global ready financial assets being a different global ready financial asset type, each of the one or more global ready financial assets including regionally optimized logic for providing regionally optimized modeling and functionality associated with that type of global ready financial asset for two or more distinct regions;
providing a global ready financial application;
a user accessing the global ready financial application through a user interface;
determining the region associated with the user; and
composing a regionally optimized global ready financial application that is optimized for the determined region associated with the user, the regionally optimized global ready financial application being composed using the regionally optimized modeling and functionality logic for the determined region associated with user of at least one of the one or more global ready financial assets.

2. The computing system implemented method for providing global ready financial applications of claim 1 wherein at least one of the one or more global ready financial assets is selected from the group of global ready financial assets consisting of:
an identity global ready financial asset to provide the identity model, logic, and functionality to the global ready financial application for the two or more regions;
a tax model global ready financial asset to provide the tax model, logic, and functionality to be used by the global ready financial application in the two or more regions;
a payment gateway global ready financial asset to provide the localized payment gateway model, logic, and functionality to be used by the global ready financial application in the two or more regions
a billing global ready financial asset to provide the billing and payment model, logic, and functionality to be used by the global ready financial application in the two or more regions;
a bank feeds global ready financial asset to provide the bank feed model, logic, and functionality to the global ready financial application for the two or more regions;
a currency conversion global ready financial asset to provide the local currency model, logic, and functionality to the global ready financial application for the two or more regions; and
a user contribution and/or local templates global ready financial asset to provide the personalized service and template model, logic, and functionality to the global ready financial application for the two or more regions.

3. The computing system implemented method for providing global ready financial applications of claim 1 wherein the global ready financial application is selected from the group of global ready financial applications consisting of:
an application for generating profit and loss reports;
an application for generating invoices;
an application for generating payroll;
an application for providing bank statements or on-line banking feeds;
an application for generating any financial reports;
an application for calculating tax;
an application for paying taxes;
an accounting application;
a point of sale application; and
an application for tracking and processing inventory.

4. The computing system implemented method for providing global ready financial applications of claim 1 wherein the region associated with the user is determined based, at least in part, on the IP address associated with a computing system used by the user to access the global ready financial application.

5. The computing system implemented method for providing global ready financial applications of claim 1 wherein the region associated with the user is determined based, at least in part, on the browser context, and/or default language associated with the browser, used to access the global ready financial application.

6. The computing system implemented method for providing global ready financial applications of claim 1 wherein the region associated with the user is determined based, at least in part, on profile data provided by the user.

7. A computing system implemented method for providing global ready financial applications comprising the following, which when executed individually or collectively by any set of one or more processors perform a process including:
providing one or more global ready financial assets, each of the one or more global ready financial assets being a different global ready financial asset type, each of the one or more global ready financial assets including regionally optimized logic for providing regionally optimized modeling and functionality associated with that type of global ready financial asset for two or more distinct regions;
providing a global ready financial application;
a first user accessing the global ready financial application through a user interface;
determining a first region associated with the first user;
composing a first regionally optimized global ready financial application that is optimized for the determined first region associated with the first user, the first regionally optimized global ready financial application being composed using the regionally optimized modeling and functionality for the determined first region of at least one of the one or more global ready financial assets;
a second user accessing the global ready financial application through a user interface;
determining a second region associated with the second user, the second region associated with the second user being distinct from the first region associated with the first user; and
composing a second regionally optimized global ready financial application that is optimized for the determined second region associated with the second user, the second regionally optimized global ready financial application being composed using the regionally optimized modeling and functionality for the determined second region of at least one of the one or more global ready financial assets.

8. The computing system implemented method for providing global ready financial applications of claim 7 wherein at least one of the one or more global ready financial assets is selected from the group of global ready financial assets consisting of:
an identity global ready financial asset to provide the identity model, logic, and functionality to the global ready financial application for the two or more regions;
a tax model global ready financial asset to provide the tax model, logic, and functionality to be used by the global ready financial application in the two or more regions;
a payment gateway global ready financial asset to provide the localized payment gateway model, logic, and functionality to be used by the global ready financial application in the two or more regions
a billing global ready financial asset to provide the billing and payment model, logic, and functionality to be used by the global ready financial application in the two or more regions;
a bank feeds global ready financial asset to provide the bank feed model, logic, and functionality to the global ready financial application for the two or more regions;
a currency conversion global ready financial asset to provide the local currency model, logic, and functionality to the global ready financial application for the two or more regions; and
a user contribution and/or local templates global ready financial asset to provide the personalized service and template model, logic, and functionality to the global ready financial application for the two or more regions.

9. The computing system implemented method for providing global ready financial applications of claim 7 wherein the global ready financial application is selected from the group of global ready financial applications consisting of:
an application for generating profit and loss reports;
an application for generating invoices;
an application for generating payroll;
an application for providing bank statements or on-line banking feeds;
an application for generating any financial reports;
an application for calculating tax;
an application for paying taxes;
an accounting application;
a point of sale application; and
an application for tracking and processing inventory.

10. The computing system implemented method for providing global ready financial applications of claim 7 wherein the first and/or second region associated with the first and second users is determined based, at least in part, on the IP address associated with computing systems used by the first and second users to access the global ready financial application.

11. The computing system implemented method for providing global ready financial applications of claim 7 wherein the first and/or second regions associated with the first and second users is determined based, at least in part, on the browser context, and/or default language associated with the browsers, used to access the global ready financial application.

12. The computing system implemented method for providing global ready financial applications of claim 7 wherein the first and/or second regions associated with the first and second users is determined based, at least in part, on profile data provided by the first and second users.

13. A computing system implemented method for providing global ready financial applications comprising the following, which when executed individually or collectively by any set of one or more processors perform a process including:
providing one or more global ready financial assets, each of the one or more global ready financial assets being a different global ready financial asset type, each of the one or more global ready financial assets including regionally optimized logic for providing regionally optimized modeling and functionality associated with that type of global ready financial asset for two or more distinct regions;
providing a first global ready financial application;
providing a second global ready financial application, the second global ready financial application being distinct from the first global ready financial application;
a user accessing the first global ready financial application through a user interface;
determining the region associated with the user;
composing a regionally optimized first global ready financial application that is optimized for the determined region associated with the user, the regionally optimized first global ready financial application being composed using the regionally optimized modeling and functionality for the determined region associated with user of at least one of the one or more global ready financial assets;
a user accessing the second global ready financial application through a user interface; and
composing a regionally optimized second global ready financial application that is optimized for the determined region associated with the user, the regionally optimized second global ready financial application instance being composed using the regionally optimized modeling and functionality for the determined region associated with user of at least one of the one or more global ready financial assets.

14. The computing system implemented method for providing global ready financial applications of claim 13 wherein at least one of the one or more global ready financial assets is selected from the group of global ready financial assets consisting of:
an identity global ready financial asset to provide the identity model, logic, and functionality to the first and second global ready financial applications for the two or more regions;
a tax model global ready financial asset to provide the tax model, logic, and functionality to be used by the first and second global ready financial applications in the two or more regions;
a payment gateway global ready financial asset to provide the localized payment gateway model, logic, and functionality to be used by the first and second global ready financial applications in the two or more regions
a billing global ready financial asset to provide the billing and payment model, logic, and functionality to be used by the first and second global ready financial applications in the two or more regions;
a bank feeds global ready financial asset to provide the bank feed model, logic, and functionality to the first and second global ready financial applications for the two or more regions;
a currency conversion global ready financial asset to provide the local currency model, logic, and functionality to the first and second global ready financial applications for the two or more regions; and
a user contribution and/or local templates global ready financial asset to provide the personalized service and template model, logic, and functionality to the first and second global ready financial applications for the two or more regions.

15. The computing system implemented method for providing global ready financial applications of claim 13 wherein at least one of the first global ready financial application and/or the second global ready financial application is selected from the group of global ready financial applications consisting of:
an application for generating profit and loss reports;
an application for generating invoices;
an application for generating payroll;
an application for providing bank statements or on-line banking feeds;
an application for generating any financial reports;
an application for calculating tax;
an application for paying taxes;
an accounting application;
a point of sale application; and
an application for tracking and processing inventory.

16. The computing system implemented method for providing global ready financial applications of claim 13 wherein the region associated with a user is determined based, at least in part, on the IP address associated with a computing system used by the user to access the global ready financial application.

17. The computing system implemented method for providing global ready financial applications of claim 13 wherein the region associated with a user is determined based, at least in part, on the browser context, and/or default language associated with the browser, used to access the global ready financial application.

18. The computing system implemented method for providing global ready financial applications of claim 13 wherein the region associated with a user is determined based, at least in part, on profile data provided by the user.

19. A system for providing global ready financial applications comprising:
one or more global ready financial assets, each of the one or more global ready financial assets being a different global ready financial asset type, each of the one or more global ready financial assets including regionally optimized logic for providing regionally optimized modeling and functionality associated with that type of global ready financial asset for two or more distinct regions;
at least one global ready financial application;
a user interface;
at least one processor; and
at least one memory coupled to the at least one processor, the at least one memory having stored therein instructions which when executed by any set of the one or more processors, perform a process for providing global ready financial applications, the process for providing global ready financial applications including:
a user accessing the global ready financial application through a user interface;
determining the region associated with the user; and
composing a regionally optimized global ready financial application that is optimized for the determined region associated with the user, the regionally optimized global ready financial application being composed using the regionally optimized modeling and functionality logic for the determined region associated with user of at least one of the one or more global ready financial assets.

20. The system for providing global ready financial applications of claim 19 wherein at least one of the one or more global ready financial assets is selected from the group of global ready financial assets consisting of:
an identity global ready financial asset to provide the identity model, logic, and functionality to the global ready financial application for the two or more regions;
a tax model global ready financial asset to provide the tax model, logic, and functionality to be used by the global ready financial application in the two or more regions;
a payment gateway global ready financial asset to provide the localized payment gateway model, logic, and functionality to be used by the global ready financial application in the two or more regions
a billing global ready financial asset to provide the billing and payment model, logic, and functionality to be used by the global ready financial application in the two or more regions;
a bank feeds global ready financial asset to provide the bank feed model, logic, and functionality to the global ready financial application for the two or more regions;
a currency conversion global ready financial asset to provide the local currency model, logic, and functionality to the global ready financial application for the two or more regions; and
a user contribution and/or local templates global ready financial asset to provide the personalized service and template model, logic, and functionality to the global ready financial application for the two or more regions.

21. The system for providing global ready financial applications of claim 19 wherein the global ready financial application is selected from the group of global ready financial applications consisting of:
an application for generating profit and loss reports;
an application for generating invoices;
an application for generating payroll;
an application for providing bank statements or on-line banking feeds;
an application for generating any financial reports;
an application for calculating tax;
an application for paying taxes;
an accounting application;
a point of sale application; and
an application for tracking and processing inventory.

22. The system for providing global ready financial applications of claim 19 wherein the region associated with the user is determined based, at least in part, on the IP address associated with a computing system used by the user to access the global ready financial application.

23. The system for providing global ready financial applications of claim 19 wherein the region associated with the user is determined based, at least in part, on the browser context, and/or default language associated with the browser, used to access the global ready financial application.

24. The system for providing global ready financial applications of claim 19 wherein the region associated with the user is determined based, at least in part, on profile data provided by the user.

25. A system for providing global ready financial applications comprising:
one or more global ready financial assets, each of the one or more global ready financial assets being a different global ready financial asset type, each of the one or more global ready financial assets including regionally optimized logic for providing regionally optimized modeling and functionality associated with that type of global ready financial asset for two or more distinct regions;
at least one global ready financial application;
a user interface;
at least one processor; and
at least one memory coupled to the at least one processor, the at least one memory having stored therein instructions which when executed by any set of the one or more processors, perform a process for providing global ready financial applications, the process for providing global ready financial applications including:
a first user accessing the global ready financial application through a user interface;
determining a first region associated with the first user;
composing a first regionally optimized global ready financial application that is optimized for the determined first region associated with the first user, the first regionally optimized global ready financial application being composed using the regionally optimized modeling and functionality for the determined first region of at least one of the one or more global ready financial assets;
a second user accessing the global ready financial application through a user interface;
determining a second region associated with the second user, the second region associated with the second user being distinct from the first region associated with the first user; and
composing a second regionally optimized global ready financial application that is optimized for the determined second region associated with the second user, the second regionally optimized global ready financial application being composed using the regionally optimized modeling and functionality for the determined second region of at least one of the one or more global ready financial assets.

26. The system for providing global ready financial applications of claim 25 wherein at least one of the one or more global ready financial assets is selected from the group of global ready financial assets consisting of:
an identity global ready financial asset to provide the identity model, logic, and functionality to the global ready financial application for the two or more regions;
a tax model global ready financial asset to provide the tax model, logic, and functionality to be used by the global ready financial application in the two or more regions;
a payment gateway global ready financial asset to provide the localized payment gateway model, logic, and functionality to be used by the global ready financial application in the two or more regions
a billing global ready financial asset to provide the billing and payment model, logic, and functionality to be used by the global ready financial application in the two or more regions;
a bank feeds global ready financial asset to provide the bank feed model, logic, and functionality to the global ready financial application for the two or more regions;
a currency conversion global ready financial asset to provide the local currency model, logic, and functionality to the global ready financial application for the two or more regions; and
a user contribution and/or local templates global ready financial asset to provide the personalized service and template model, logic, and functionality to the global ready financial application for the two or more regions.

27. The system for providing global ready financial applications of claim 25 wherein the global ready financial application is selected from the group of global ready financial applications consisting of:
an application for generating profit and loss reports;
an application for generating invoices;
an application for generating payroll;
an application for providing bank statements or on-line banking feeds;
an application for generating any financial reports;
an application for calculating tax;
an application for paying taxes;
an accounting application;
a point of sale application; and
an application for tracking and processing inventory.

28. The system for providing global ready financial applications of claim 25 wherein the first and/or second region associated with the first and second users is determined based, at least in part, on the IP address associated with computing systems used by the first and second users to access the global ready financial application.

29. The system for providing global ready financial applications of claim 25 wherein the first and/or second regions associated with the first and second users is determined based, at least in part, on the browser context, and/or default language associated with the browsers, used to access the global ready financial application.

30. The system for providing global ready financial applications of claim 25 wherein the first and/or second regions associated with the first and second users is determined based, at least in part, on profile data provided by the first and second users.

31. A system for providing global ready financial applications comprising:
one or more global ready financial assets, each of the one or more global ready financial assets being a different global ready financial asset type, each of the one or more global ready financial assets including regionally optimized logic for providing regionally optimized modeling and functionality associated with that type of global ready financial asset for two or more distinct regions;
a first global ready financial application;
a second global ready financial application, the second global ready financial application being distinct from the first global ready financial application;
a user interface;
at least one processor; and
at least one memory coupled to the at least one processor, the at least one memory having stored therein instructions which when executed by any set of the one or more processors, perform a process for providing global ready financial applications, the process for providing global ready financial applications including:
a user accessing the first global ready financial application through a user interface;
determining the region associated with the user;
composing a regionally optimized first global ready financial application that is optimized for the determined region associated with the user, the regionally optimized first global ready financial application being composed using the regionally optimized modeling and functionality for the determined region associated with user of at least one of the one or more global ready financial assets;
a user accessing the second global ready financial application through a user interface; and
composing a regionally optimized second global ready financial application that is optimized for the determined region associated with the user, the regionally optimized second global ready financial application instance being composed using the regionally optimized modeling and functionality for the determined region associated with user of at least one of the one or more global ready financial assets.

32. The system for providing global ready financial applications of claim 31 wherein at least one of the one or more global ready financial assets is selected from the group of global ready financial assets consisting of:
an identity global ready financial asset to provide the identity model, logic, and functionality to the first and second global ready financial applications for the two or more regions;
a tax model global ready financial asset to provide the tax model, logic, and functionality to be used by the first and second global ready financial applications in the two or more regions;
a payment gateway global ready financial asset to provide the localized payment gateway model, logic, and functionality to be used by the first and second global ready financial applications in the two or more regions
a billing global ready financial asset to provide the billing and payment model, logic, and functionality to be used by the first and second global ready financial applications in the two or more regions;
a bank feeds global ready financial asset to provide the bank feed model, logic, and functionality to the first and second global ready financial applications for the two or more regions;
a currency conversion global ready financial asset to provide the local currency model, logic, and functionality to the first and second global ready financial applications for the two or more regions; and
a user contribution and/or local templates global ready financial asset to provide the personalized service and template model, logic, and functionality to the first and second global ready financial applications for the two or more regions.

33. The system for providing global ready financial applications of claim 31 wherein at least one of the first global ready financial application and/or the second global ready financial application is selected from the group of global ready financial applications consisting of:
an application for generating profit and loss reports;
an application for generating invoices;
an application for generating payroll;
an application for providing bank statements or on-line banking feeds;
an application for generating any financial reports;
an application for calculating tax;
an application for paying taxes;
an accounting application;
a point of sale application; and
an application for tracking and processing inventory.

34. The system for providing global ready financial applications of claim 31 wherein the region associated with a user is determined based, at least in part, on the IP address associated with a computing system used by the user to access the global ready financial application.

35. The system for providing global ready financial applications of claim 31 wherein the region associated with a user is determined based, at least in part, on the browser context, and/or default language associated with the browser, used to access the global ready financial application.

36. The system for providing global ready financial applications of claim 31 wherein the region associated with a user is determined based, at least in part, on profile data provided by the user.
